(19) United States
(12) Patent Application Publication
(10) Pub. No.: US 2026/0173013 A1
(43) Pub. Date: Jun. 18, 2026

(54) DIGITAL TWIN ASSISTED MULTI-HYPOTHESIS POSITIONING

(71) Applicant: QUALCOMM Incorporated, San Diego, CA (US)

(72) Inventors: Mohammed Ali Mohammed HIRZALLAH, San Marcos, CA (US); Rajat PRAKASH, San Diego, CA (US); Xiaoxia ZHANG, San Diego, CA (US)

(21) Appl. No.: 18/983,570

(22) Filed: Dec. 17, 2024

(51) Int. Cl. H04W 64/00

(52) U.S. Cl. CPC H04W 64/00

(57) ABSTRACT

A multi-hypothesis positioning method includes: receiving, at an apparatus from a digital twin function, multi-hypothesis positioning assistance data; and determining to implement multi-hypothesis positioning based on at least a subset of the multi-hypothesis positioning assistance data.

### BACKGROUND

Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service, a fourth-generation (4G) service (e.g., Long Term Evolution (LTE) or WiMax®), a fifth-generation (5G) service (e.g., 5G New Radio (NR)), etc., with a sixth-generation (6G) service in development. There are presently many different types of wireless communication systems in use, including Cellular and Personal Communications Service (PCS) systems. Examples of known cellular systems include the cellular Analog Advanced Mobile Phone System (AMPS), and digital cellular systems based on Code Division Multiple Access (CDMA), Frequency Division Multiple Access (FDMA), Orthogonal Frequency Division Multiple Access (OFDMA), Time Division Multiple Access (TDMA), the Global System for Mobile access (GSM) variation of TDMA, etc.

A fifth generation (5G) mobile standard calls for higher data transfer speeds, greater numbers of connections, and better coverage, among other improvements. The 5G standard, according to the Next Generation Mobile Networks Alliance, is designed to provide data rates of several tens of megabits per second to each of tens of thousands of users, with 1 gigabit per second to tens of workers on an office floor. Several hundreds of thousands of simultaneous connections should be supported in order to support large sensor deployments. Consequently, the spectral efficiency of 5G mobile communications should be significantly enhanced compared to the current 4G standard. Furthermore, signaling efficiencies should be enhanced and latency should be substantially reduced compared to current standards.

It is often desirable to know the location and/or motion (e.g., speed or velocity) of a user equipment (UE), e.g., a cellular phone, with the terms “location” and “position” being synonymous and used interchangeably herein. A location services (LCS) client may desire to know the location of the UE and may communicate with a location center in order to request the location of the UE. The location center and the UE may exchange messages, as appropriate, to obtain a location estimate for the UE. The location center may return the location estimate to the LCS client, e.g., for use in one or more applications.

### SUMMARY

An example multi-hypothesis positioning method includes: receiving, at an apparatus from a digital twin function, multi-hypothesis positioning assistance data; and determining to implement multi-hypothesis positioning based on at least a subset of the multi-hypothesis positioning assistance data.

An example apparatus, for implementing multi-hypothesis positioning, includes: at least one transceiver; at least one memory; at least one processor, communicatively coupled to the at least one transceiver and the at least one memory, configured to: receive, via the at least one transceiver from a digital twin function, multi-hypothesis positioning assistance data; and determine to implement multi-hypothesis positioning based on at least a subset of the multi-hypothesis positioning assistance data.

Another example apparatus, for implementing multi-hypothesis positioning, includes: means for receiving, from a digital twin function, multi-hypothesis positioning assistance data; and means for determining to implement multi-hypothesis positioning based on at least a subset of the multi-hypothesis positioning assistance data.

An example non-transitory, processor-readable storage medium includes processor-readable instructions to cause at least one processor of an apparatus to: receive, from a digital twin function, multi-hypothesis positioning assistance data; and determine to implement multi-hypothesis positioning based on at least a subset of the multi-hypothesis positioning assistance data.

An example multi-hypothesis positioning assistance data method includes: determining, at an apparatus, multi-hypothesis positioning assistance data by analyzing a digital twin of a positioning scenario of a wireless signaling device; and transmitting the multi-hypothesis positioning assistance data from the apparatus to an entity that is configured to perform multi-hypothesis positioning.

An example apparatus, for providing multi-hypothesis positioning assistance data, includes: at least one transceiver; at least one memory; at least one processor, communicatively coupled to the at least one transceiver and the at least one memory, configured to: determine the multi-hypothesis positioning assistance data by analyzing a digital twin of a positioning scenario of a wireless signaling device; and transmit, via the at least one transceiver, the multi-hypothesis positioning assistance data to an entity that is configured to perform multi-hypothesis positioning.

Another example apparatus, for providing multi-hypothesis positioning assistance data, includes: means for determining multi-hypothesis positioning assistance data by analyzing a digital twin of a positioning scenario of a wireless signaling device; and means for transmitting the multi-hypothesis positioning assistance data from the apparatus to an entity that is configured to perform multi-hypothesis positioning.

Another example non-transitory, processor-readable storage medium includes processor-readable instructions to cause at least one processor of an apparatus to: determine multi-hypothesis positioning assistance data by analyzing a digital twin of a positioning scenario of a wireless signaling device; and transmit the multi-hypothesis positioning assistance data from the apparatus to an entity that is configured to perform multi-hypothesis positioning.

### BRIEF DESCRIPTION OF THE DRAWINGS

FIG. 1 is a simplified diagram of an example wireless communications system.

FIG. 2 is a block diagram of components of an example user equipment shown in FIG. 1.

FIG. 3 is a block diagram of components of an example transmission/reception point.

FIG. 4 is a block diagram of components of a server, various examples of which are shown in FIG. 1.

FIG. 5 is a block diagram of an example multi-hypothesis positioning entity.

FIG. 6 is block flow diagram of an example digital twin function.

FIG. 7 is a perspective view of an environment including mobile devices, transmission/reception points, and other objects.

FIG. 8 is a ray diagram of a portion of the environment shown in FIG. 7.

FIG. 9A is a graph of power and timing of multiple receptions of a signal travelling different paths between a transmitter and a receiver shown in FIG. 8.

FIG. 9B is a graph of different reception angles of the multiple receptions of the signal shown in FIG. 9A.

FIG. 9C is a graph of different reception phases of the multiple receptions of the signal shown in FIG. 9A.

FIG. 10 is a block diagram of an artificial intelligence/machine learning model, inputs thereto, and outputs therefrom.

FIG. 11 is a signal and processing flow diagram for determining and using a digital twin to provide multi-hypothesis positioning assistance data.

FIG. 12 is a block diagram of training and using an artificial intelligence/machine learning model for determining target location.

FIG. 13 is a block diagram of training and using an artificial intelligence/machine learning model for determining intermediate results for determining a target location, and using a positioning model to determine target location.

FIG. 14 is a block flow diagram of a multi-hypothesis positioning assistance data method.

FIG. 15 is a block flow diagram of a multi-hypothesis positioning method.

### DETAILED DESCRIPTION

Techniques are discussed herein for producing multi-hypothesis positioning (MHP) assistance data (AD). For example, a digital twin function (DTF) may establish a digital twin of a wireless signaling environment (e.g., a wireless signaling channel) and use the digital twin to produce insights and recommendations for multi-hypothesis positioning. In MHP, multiple hypotheses are developed and analyzed for each of one or more pieces of positioning information that can be used to determine position of a target wireless signaling device. For example, multiple hypotheses may be developed and analyzed for each of one or more signal measurements (e.g., signal transmission time, signal reception time, signal reception power, signal reception phase, line-of-sight/non-line-of-sight signal reception, etc.). The multiple hypotheses may be used to determine the position of the target wireless signaling device (i.e., a device configured to transmit wireless signals, or configured to receive wireless signals, or configured to transmit and receive wireless signals), e.g., a UE (User Equipment) or base station (e.g., gNB). The DTF may produce MHP AD indicative of, for example, feasibility of using MHP to determine a position estimate of a target mobile device, one or more MHP parameters, and/or one or more conditions affecting whether to implement MHP. The DTF may provide the MHP AD to an apparatus for implementing MHP, and the apparatus may determine (e.g., based on digital twin information aside from the MHP AD, and/or based on the MHP AD) whether (and if so, how) to implement MHP. As another example, various multi-hypothesis parameters (conditions, assistance data, area/scenarios, signal parameters, number of hypotheses, preferred hypotheses, preferred probability distribution(s)) may be provided to an entity (e.g., a user equipment) for performance of multi-hypothesis positioning. Signaling may include various call flow methods (request hypothesis, request assistance data, report assistance data, report digital twin results, etc.). These are examples, and other examples may be implemented.

Items and/or techniques described herein may provide one or more of the following capabilities, and possibly one or more other capabilities not mentioned. Positioning accuracy may be improved. Multi-hypothesis positioning may be selectively implemented, e.g., where such implementation will improve positioning accuracy. Multi-hypothesis positioning assistance data may be used to train an artificial intelligence/machine learning (AIML) model, and/or as input to the AIML model, for use in determining a location estimate of a target mobile device. Other capabilities may be provided and not every implementation according to the disclosure must provide any, let alone all, of the capabilities discussed. Further, it may be possible for an effect noted above to be achieved by means other than that noted, and a noted item/technique may not necessarily yield the noted effect.

Obtaining the locations of mobile devices that are accessing a wireless network may be useful for many applications including, for example, emergency calls, personal navigation, consumer asset tracking, locating a friend or family member, etc. In industrial applications, the location of a mobile device may be necessary for asset tracking, robotic control, and other kinematic operations which may require a precise location of an end effector. Existing positioning methods include methods based on measuring radio signals transmitted from a variety of devices or entities including satellite vehicles (SVs) and terrestrial radio sources in a wireless network such as base stations and access points. Stations in a wireless network may be configured to transmit reference signals (RS) to enable mobile device to perform positioning measurements. It is expected that standardization for the 5G wireless networks will include support for various positioning methods, which may utilize reference signals transmitted by base stations in a manner similar to which LTE wireless networks currently utilize Positioning Reference Signals (PRS) and/or Cell-specific Reference Signals (CRS) for position determination. The term “RS” (including different types of RS, e.g., PRS, CRS, SRS) includes the singular (reference signal) and the plural (reference signals).

The description herein may refer to sequences of actions to be performed, for example, by elements of a computing device. Various actions described herein can be performed by specific circuits (e.g., an application specific integrated circuit (ASIC)), by program instructions being executed by one or more processors, or by a combination of both. Sequences of actions described herein may be embodied within a non-transitory computer-readable medium having stored thereon a corresponding set of computer instructions that upon execution would cause an associated processor to perform the functionality described herein. Thus, the various examples described herein may be embodied in a number of different forms, all of which are within the scope of the disclosure, including claimed subject matter.

As used herein, the terms “user equipment” (UE) and “base station” are not specific to or otherwise limited to any particular Radio Access Technology (RAT), unless otherwise noted. In general, a UE may be any wireless communication device (e.g., a mobile phone, router, tablet computer, laptop computer, consumer asset tracking device, Internet of Things (IoT) device, automobile, etc.) used to communicate over a wireless communications network. A UE may be mobile or may (e.g., at certain times) be stationary, and may communicate with a Radio Access Network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or UT, a “mobile terminal,” a “mobile station,” a “mobile device,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, WiFi® short-range wireless communication technology networks (e.g., based on IEEE (Institute of Electrical and Electronics Engineers) 802.11, etc.) and so on. Two or more UEs may communicate directly in addition to or instead of passing information to each other through a network.

A base station may operate according to one of several RATs in communication with UEs depending on the network in which it is deployed. Examples of a base station include an Access Point (AP), a Network Node, a NodeB, an evolved NodeB (eNB), or a general Node B (gNodeB, gNB). In addition, in some systems a base station may provide purely edge node signaling functions while in other systems it may provide additional control and/or network management functions.

UEs may be embodied by any of a number of types of devices including but not limited to printed circuit (PC) cards, compact flash devices, external or internal modems, wireless or wireline phones, smartphones, tablets, consumer asset tracking devices, asset tags, and so on. A communication link through which UEs can send signals to a RAN is called an uplink channel (e.g., a reverse traffic channel, a reverse control channel, an access channel, etc.). A communication link through which the RAN can send signals to UEs is called a downlink or forward link channel (e.g., a paging channel, a control channel, a broadcast channel, a forward traffic channel, etc.). As used herein the term traffic channel (TCH) can refer to either an uplink/reverse or downlink/forward traffic channel.

As used herein, the term “cell” or “sector” may correspond to one of a plurality of cells of a base station, or to the base station itself, depending on the context. The term “cell” may refer to a logical communication entity used for communication with a base station (for example, over a carrier), and may be associated with an identifier for distinguishing neighboring cells (for example, a physical cell identifier (PCID), a virtual cell identifier (VCID)) operating via the same or a different carrier. In some examples, a carrier may support multiple cells, and different cells may be configured according to different protocol types (for example, machine-type communication (MTC), narrowband Internet-of-Things (NB-IoT), enhanced mobile broadband (eMBB), or others) that may provide access for different types of devices. In some examples, the term “cell” may refer to a portion of a geographic coverage area (for example, a sector) over which the logical entity operates.

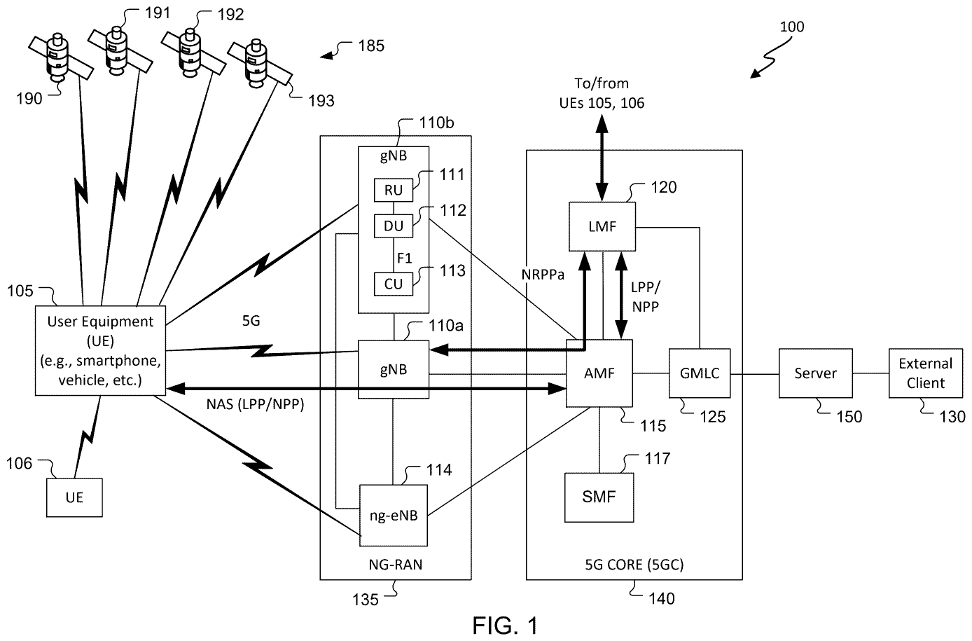

Referring to FIG. 1, an example of a communication system 100 includes a UE 105, a UE 106, a Radio Access Network (RAN), here a Fifth Generation (5G) Next Generation (NG) RAN (NG-RAN) 135, a 5G Core Network (5GC) 140, and a server 150. The UE 105 and/or the UE 106 may be, e.g., an IoT device, a location tracker device, a cellular telephone, a vehicle (e.g., a car, a truck, a bus, a boat, etc.), or another device. A 5G network may also be referred to as a New Radio (NR) network; NG-RAN 135 may be referred to as a 5G RAN or as an NR RAN; and 5GC 140 may be referred to as an NG Core network (NGC). Standardization of an NG-RAN and 5GC is ongoing in the 3rd Generation Partnership Project (3GPP). Accordingly, the NG-RAN 135 and the 5GC 140 may conform to current or future standards for 5G support from 3GPP. The NG-RAN 135 may be another type of RAN, e.g., a 3G RAN, a 4G Long Term Evolution (LTE) RAN, etc. The UE 106 may be configured and coupled similarly to the UE 105 to send and/or receive signals to/from similar other entities in the system 100, but such signaling is not indicated in FIG. 1 for the sake of simplicity of the figure. Similarly, the discussion focuses on the UE 105 for the sake of simplicity. The communication system 100 may utilize information from a constellation 185 of satellite vehicles (SVs) 190, 191, 192, 193 for a Satellite Positioning System (SPS) (e.g., a Global Navigation Satellite System (GNSS)) like the Global Positioning System (GPS), the Global Navigation Satellite System (GLONASS), Galileo, or Beidou or some other local or regional SPS such as the Indian Regional Navigational Satellite System (IRNSS), the European Geostationary Navigation Overlay Service (EGNOS), or the Wide Area Augmentation System (WAAS). Additional components of the communication system 100 are described below. The communication system 100 may include additional or alternative components.

As shown in FIG. 1, the NG-RAN 135 includes NR nodeBs (gNBs) 110a, 110b, and a next generation eNodeB (ng-eNB) 114, and the 5GC 140 includes an Access and Mobility Management Function (AMF) 115, a Session Management Function (SMF) 117, a Location Management Function (LMF) 120, and a Gateway Mobile Location Center (GMLC) 125. The gNBs 110a, 110b and the ng-eNB 114 are communicatively coupled to each other, are each configured to bi-directionally wirelessly communicate with the UE 105, and are each communicatively coupled to, and configured to bi-directionally communicate with, the AMF 115. The gNBs 110a, 110b, and the ng-eNB 114 may be referred to as base stations (BSs). The AMF 115, the SMF 117, the LMF 120, and the GMLC 125 are communicatively coupled to each other, and the GMLC is communicatively coupled to an external client 130. The SMF 117 may serve as an initial contact point of a Service Control Function (SCF) (not shown) to create, control, and delete media sessions. Base stations such as the gNBs 110a, 110b and/or the ng-eNB 114 may be a macro cell (e.g., a high-power cellular base station), or a small cell (e.g., a low-power cellular base station), or an access point (e.g., a short-range base station configured to communicate with short-range technology such as WiFi® short-range wireless communication technology, WiFi®-Direct (WiFi®-D), Bluetooth®, Bluetooth®-low energy (BLE), Zigbee®, etc. One or more base stations, e.g., one or more of the gNBs 110a, 110b and/or the ng-eNB 114 may be configured to communicate with the UE 105 via multiple carriers. Each of the gNBs 110a, 110b and/or the ng-eNB 114 may provide communication coverage for a respective geographic region, e.g., a cell. Each cell may be partitioned into multiple sectors as a function of the base station antennas.

FIG. 1 provides a generalized illustration of various components, any or all of which may be utilized as appropriate, and each of which may be duplicated or omitted as necessary. Specifically, although one UE 105 is illustrated, many UEs (e.g., hundreds, thousands, millions, etc.) may be utilized in the communication system 100. Similarly, the communication system 100 may include a larger (or smaller) number of SVs (i.e., more or fewer than the four SVs 190-193 shown), gNBs 110a, 110b, ng-eNBs 114, AMFs 115, external clients 130, and/or other components. The illustrated connections that connect the various components in the communication system 100 include data and signaling connections which may include additional (intermediary) components, direct or indirect physical and/or wireless connections, and/or additional networks. Furthermore, components may be rearranged, combined, separated, substituted, and/or omitted, depending on desired functionality.

While FIG. 1 illustrates a 5G-based network, similar network implementations and configurations may be used for other communication technologies, such as 3G, Long Term Evolution (LTE), etc. Implementations described herein (be they for 5G technology and/or for one or more other communication technologies and/or protocols) may be used to transmit (or broadcast) directional synchronization signals, receive and measure directional signals at UEs (e.g., the UE 105) and/or provide location assistance to the UE 105 (via the GMLC 125 or other location server) and/or compute a location for the UE 105 at a location-capable device such as the UE 105, the gNB 110a, 110b, or the LMF 120 based on measurement quantities received at the UE 105 for such directionally-transmitted signals. The gateway mobile location center (GMLC) 125, the location management function (LMF) 120, the access and mobility management function (AMF) 115, the SMF 117, the ng-eNB (eNodeB) 114 and the gNBs (gNodeBs) 110a, 110b are examples and may be replaced by or include various other location server functionality and/or base station functionality respectively.

The system 100 is capable of wireless communication in that components of the system 100 can communicate with one another (at least some times using wireless connections) directly or indirectly, e.g., via the gNBs 110a, 110b, the ng-eNB 114, and/or the 5GC 140 (and/or one or more other devices not shown, such as one or more other base transceiver stations). For indirect communications, the communications may be altered during transmission from one entity to another, e.g., to alter header information of data packets, to change format, etc. The UE 105 may include multiple UEs and may be a mobile wireless communication device, but may communicate wirelessly and via wired connections. The UE 105 may be any of a variety of devices, e.g., a smartphone, a tablet computer, a vehicle-based device, etc., but these are examples as the UE 105 is not required to be any of these configurations, and other configurations of UEs may be used. Other UEs may include wearable devices (e.g., smart watches, smart jewelry, smart glasses or headsets, etc.). Still other UEs may be used, whether currently existing or developed in the future. Further, other wireless devices (whether mobile or not) may be implemented within the system 100 and may communicate with each other and/or with the UE 105, the gNBs 110a, 110b, the ng-eNB 114, the 5GC 140, and/or the external client 130. For example, such other devices may include internet of thing (IoT) devices, medical devices, home entertainment and/or automation devices, etc. The 5GC 140 may communicate with the external client 130 (e.g., a computer system), e.g., to allow the external client 130 to request and/or receive location information regarding the UE 105 (e.g., via the GMLC 125).

The UE 105 or other devices may be configured to communicate in various networks and/or for various purposes and/or using various technologies (e.g., 5G, Wi-Fi® communication, multiple frequencies of Wi-Fi® communication, satellite positioning, one or more types of communications (e.g., GSM (Global System for Mobiles), CDMA (Code Division Multiple Access), LTE (Long Term Evolution), V2X (Vehicle-to-Everything, e.g., V2P (Vehicle-to-Pedestrian), V2I (Vehicle-to-Infrastructure), V2V (Vehicle-to-Vehicle), etc.), IEEE 802.11p, etc.). V2X communications may be cellular (Cellular-V2X (C-V2X)) and/or WiFi® (e.g., DSRC (Dedicated Short-Range Connection)). The system 100 may support operation on multiple carriers (waveform signals of different frequencies). Multi-carrier transmitters can transmit modulated signals simultaneously on the multiple carriers. Each modulated signal may be a Code Division Multiple Access (CDMA) signal, a Time Division Multiple Access (TDMA) signal, an Orthogonal Frequency Division Multiple Access (OFDMA) signal, a Single-Carrier Frequency Division Multiple Access (SC-FDMA) signal, etc. Each modulated signal may be sent on a different carrier and may carry pilot, overhead information, data, etc. The UEs 105, 106 may communicate with each other through UE-to-UE sidelink (SL) communications by transmitting over one or more sidelink channels such as a physical sidelink synchronization channel (PSSCH), a physical sidelink broadcast channel (PSBCH), or a physical sidelink control channel (PSCCH). Direct wireless-device-to-wireless-device communications without going through a network may be referred to generally as sidelink communications without limiting the communications to a particular protocol.

The UE 105 may comprise and/or may be referred to as a device, a mobile device, a wireless device, a mobile terminal, a terminal, a mobile station (MS), a Secure User Plane Location (SUPL) Enabled Terminal (SET), or by some other name. Moreover, the UE 105 may correspond to a cellphone, smartphone, laptop, tablet, PDA, consumer asset tracking device, navigation device, Internet of Things (IoT) device, health monitors, security systems, smart city sensors, smart meters, wearable trackers, or some other portable or moveable device. Typically, though not necessarily, the UE 105 may support wireless communication using one or more Radio Access Technologies (RATs) such as Global System for Mobile communication (GSM), Code Division Multiple Access (CDMA), Wideband CDMA (WCDMA), LTE, High Rate Packet Data (HRPD), IEEE 802.11 WiFi® (also referred to as Wi-Fi®), Bluetooth® (BT), Worldwide Interoperability for Microwave Access (WiMax®), 5G new radio (NR) (e.g., using the NG-RAN 135 and the 5G 140), etc. The UE 105 may support wireless communication using a Wireless Local Area Network (WLAN) which may connect to other networks (e.g., the Internet) using a Digital Subscriber Line (DSL) or packet cable, for example. The use of one or more of these RATs may allow the UE 105 to communicate with the external client 130 (e.g., via elements of the 5GC 140 not shown in FIG. 1, or possibly via the GMLC 125) and/or allow the external client 130 to receive location information regarding the UE 105 (e.g., via the GMLC 125).

The UE 105 may include a single entity or may include multiple entities such as in a personal area network where a user may employ audio, video and/or data I/O (input/output) devices and/or body sensors and a separate wireline or wireless modem. An estimate of a location of the UE 105 may be referred to as a location, location estimate, location fix, fix, position, position estimate, or position fix, and may be geographic, thus providing location coordinates for the UE 105 (e.g., latitude and longitude) which may or may not include an altitude component (e.g., height above sea level, height above or depth below ground level, floor level, or basement level). Alternatively, a location of the UE 105 may be expressed as a civic location (e.g., as a postal address or the designation of some point or small area in a building such as a particular room or floor). A location of the UE 105 may be expressed as an area or volume (defined either geographically or in civic form) within which the UE 105 is expected to be located with some probability or confidence level (e.g., 67%, 95%, etc.). A location of the UE 105 may be expressed as a relative location comprising, for example, a distance and direction from a known location. The relative location may be expressed as relative coordinates (e.g., X, Y (and Z) coordinates) defined relative to some origin at a known location which may be defined, e.g., geographically, in civic terms, or by reference to a point, area, or volume, e.g., indicated on a map, floor plan, or building plan. In the description contained herein, the use of the term location may comprise any of these variants unless indicated otherwise. When computing the location of a UE, it is common to solve for local x, y, and possibly z coordinates and then, if desired, convert the local coordinates into absolute coordinates (e.g., for latitude, longitude, and altitude above or below mean sea level).

The UE 105 may be configured to communicate with other entities using one or more of a variety of technologies. The UE 105 may be configured to connect indirectly to one or more communication networks via one or more device-to-device (D2D) peer-to-peer (P2P) links. The D2D P2P links may be supported with any appropriate D2D radio access technology (RAT), such as LTE Direct (LTE-D), WiFi® Direct (WiFi®-D), Bluetooth®, and so on. One or more of a group of UEs utilizing D2D communications may be within a geographic coverage area of a Transmission/Reception Point (TRP) such as one or more of the gNBs 110a, 110b, and/or the ng-eNB 114. Other UEs in such a group may be outside such geographic coverage areas, or may be otherwise unable to receive transmissions from a base station. Groups of UEs communicating via D2D communications may utilize a one-to-many (1:M) system in which each UE may transmit to other UEs in the group. A TRP may facilitate scheduling of resources for D2D communications. In other cases, D2D communications may be carried out between UEs without the involvement of a TRP. One or more of a group of UEs utilizing D2D communications may be within a geographic coverage area of a TRP. Other UEs in such a group may be outside such geographic coverage areas, or be otherwise unable to receive transmissions from a base station. Groups of UEs communicating via D2D communications may utilize a one-to-many (1:M) system in which each UE may transmit to other UEs in the group. A TRP may facilitate scheduling of resources for D2D communications. In other cases, D2D communications may be carried out between UEs without the involvement of a TRP.

Base stations (BSs) in the NG-RAN 135 shown in FIG. 1 include NR Node Bs, referred to as the gNBs 110a and 110b. Pairs of the gNBs 110a, 110b in the NG-RAN 135 may be connected to one another via one or more other gNBs. Access to the 5G network is provided to the UE 105 via wireless communication between the UE 105 and one or more of the gNBs 110a, 110b, which may provide wireless communications access to the 5GC 140 on behalf of the UE 105 using 5G. In FIG. 1, the serving gNB for the UE 105 is assumed to be the gNB 110a, although another gNB (e.g., the gNB 110b) may act as a serving gNB if the UE 105 moves to another location or may act as a secondary gNB to provide additional throughput and bandwidth to the UE 105.

Base stations (BSs) in the NG-RAN 135 shown in FIG. 1 may include the ng-eNB 114, also referred to as a next generation evolved Node B. The ng-eNB 114 may be connected to one or more of the gNBs 110a, 110b in the NG-RAN 135, possibly via one or more other gNBs and/or one or more other ng-eNBs. The ng-eNB 114 may provide LTE wireless access and/or evolved LTE (eLTE) wireless access to the UE 105. One or more of the gNBs 110a, 110b and/or the ng-eNB 114 may be configured to function as positioning-only beacons which may transmit signals to assist with determining the position of the UE 105 but may not receive signals from the UE 105 or from other UEs.

The gNBs 110a, 110b and/or the ng-eNB 114 may each comprise one or more TRPs. For example, each sector within a cell of a BS may comprise a TRP, although multiple TRPs may share one or more components (e.g., share a processor but have separate antennas). The system 100 may include macro TRPs exclusively or the system 100 may have TRPs of different types, e.g., macro, pico, and/or femto TRPs, etc. A macro TRP may cover a relatively large geographic area (e.g., several kilometers in radius) and may allow unrestricted access by terminals with service subscription. A pico TRP may cover a relatively small geographic area (e.g., a pico cell) and may allow unrestricted access by terminals with service subscription. A femto or home TRP may cover a relatively small geographic area (e.g., a femto cell) and may allow restricted access by terminals having association with the femto cell (e.g., terminals for users in a home).

Each of the gNBs 110a, 110b and/or the ng-eNB 114 may include a radio unit (RU), a distributed unit (DU), and a central unit (CU). For example, the gNB 110b includes an RU 111, a DU 112, and a CU 113. The RU 111, DU 112, and CU 113 divide functionality of the gNB 110b. While the gNB 110b is shown with a single RU, a single DU, and a single CU, a gNB may include one or more RUs, one or more DUs, and/or one or more CUs. An interface between the CU 113 and the DU 112 is referred to as an F1 interface. The RU 111 is configured to perform digital front end (DFE) functions (e.g., analog-to-digital conversion, filtering, power amplification, transmission/reception) and digital beamforming, and includes a portion of the physical (PHY) layer. The RU 111 may perform the DFE using massive multiple input/multiple output (MIMO) and may be integrated with one or more antennas of the gNB 110b. The DU 112 hosts the Radio Link Control (RLC), Medium Access Control (MAC), and physical layers of the gNB 110b. One DU can support one or more cells, and each cell is supported by a single DU. The operation of the DU 112 is controlled by the CU 113. The CU 113 is configured to perform functions for transferring user data, mobility control, radio access network sharing, positioning, session management, etc. although some functions are allocated exclusively to the DU 112. The CU 113 hosts the Radio Resource Control (RRC), Service Data Adaptation Protocol (SDAP), and Packet Data Convergence Protocol (PDCP) protocols of the gNB 110b. The UE 105 may communicate with the CU 113 via RRC, SDAP, and PDCP layers, with the DU 112 via the RLC, MAC, and PHY layers, and with the RU 111 via the PHY layer.

As noted, while FIG. 1 depicts nodes configured to communicate according to 5G communication protocols, nodes configured to communicate according to other communication protocols, such as, for example, an LTE protocol or IEEE 802.11x protocol, may be used. For example, in an Evolved Packet System (EPS) providing LTE wireless access to the UE 105, a RAN may comprise an Evolved Universal Mobile Telecommunications System (UMTS) Terrestrial Radio Access Network (E-UTRAN) which may comprise base stations comprising evolved Node Bs (eNBs). A core network for EPS may comprise an Evolved Packet Core (EPC). An EPS may comprise an E-UTRAN plus EPC, where the E-UTRAN corresponds to the NG-RAN 135 and the EPC corresponds to the 5GC 140 in FIG. 1.

The gNBs 110a, 110b and the ng-eNB 114 may communicate with the AMF 115, which, for positioning functionality, communicates with the LMF 120. The AMF 115 may support mobility of the UE 105, including cell change and handover and may participate in supporting a signaling connection to the UE 105 and possibly data and voice bearers for the UE 105. The LMF 120 may communicate directly with the UE 105, e.g., through wireless communications, or directly with the gNBs 110a, 110b and/or the ng-eNB 114. The LMF 120 may support positioning of the UE 105 when the UE 105 accesses the NG-RAN 135 and may support position procedures/methods such as Assisted GNSS (A-GNSS), Observed Time Difference of Arrival (OTDOA) (e.g., Downlink (DL) OTDOA or Uplink (UL) OTDOA), Round Trip Time (RTT), Multi-Cell RTT, Real Time Kinematic (RTK), Precise Point Positioning (PPP), Differential GNSS (DGNSS), Enhanced Cell ID (E-CID), angle of arrival (AoA), angle of departure (AoD), and/or other position methods. The LMF 120 may process location services requests for the UE 105, e.g., received from the AMF 115 or from the GMLC 125. The LMF 120 may be connected to the AMF 115 and/or to the GMLC 125. The LMF 120 may be referred to by other names such as a Location Manager (LM), Location Function (LF), commercial LMF (CLMF), or value added LMF (VLMF). A node/ system that implements the LMF 120 may additionally or alternatively implement other types of location-support modules, such as an Enhanced Serving Mobile Location Center (E-SMLC) or a Secure User Plane Location (SUPL) Location Platform (SLP). At least part of the positioning functionality (including derivation of the location of the UE 105) may be performed at the UE 105 (e.g., using signal measurements obtained by the UE 105 for signals transmitted by wireless nodes such as the gNBs 110a, 110b and/or the ng-eNB 114, and/or assistance data provided to the UE 105, e.g., by the LMF 120). The AMF 115 may serve as a control node that processes signaling between the UE 105 and the 5GC 140, and may provide QoS (Quality of Service) flow and session management. The AMF 115 may support mobility of the UE 105 including cell change and handover and may participate in supporting signaling connection to the UE 105.

The server 150, e.g., a cloud server, is configured to obtain and provide location estimates of the UE 105 to the external client 130. The server 150 may, for example, be configured to run a microservice/service that obtains the location estimate of the UE 105. The server 150 may, for example, pull the location estimate from (e.g., by sending a location request to) the UE 105, one or more of the gNBs 110a, 110b (e.g., via the RU 111, the DU 112, and the CU 113) and/or the ng-eNB 114, and/or the LMF 120. As another example, the UE 105, one or more of the gNBs 110a, 110b (e.g., via the RU 111, the DU 112, and the CU 113), and/or the LMF 120 may push the location estimate of the UE 105 to the server 150.

The GMLC 125 may support a location request for the UE 105 received from the external client 130 via the server 150 and may forward such a location request to the AMF 115 for forwarding by the AMF 115 to the LMF 120 or may forward the location request directly to the LMF 120. A location response from the LMF 120 (e.g., containing a location estimate for the UE 105) may be returned to the GMLC 125 either directly or via the AMF 115 and the GMLC 125 may then return the location response (e.g., containing the location estimate) to the external client 130 via the server 150. The GMLC 125 is shown connected to both the AMF 115 and LMF 120, though may not be connected to the AMF 115 or the LMF 120 in some implementations.

As further illustrated in FIG. 1, the LMF 120 may communicate with the gNBs 110a, 110b and/or the ng-eNB 114 using a New Radio Position Protocol A (which may be referred to as NPPa or NRPPa), which may be defined in 3GPP Technical Specification (TS) 38.455. NRPPa may be the same as, similar to, or an extension of the LTE Positioning Protocol A (LPPa) defined in 3GPP TS 36.455, with NRPPa messages being transferred between the gNB 110a (or the gNB 110b) and the LMF 120, and/or between the ng-eNB 114 and the LMF 120, via the AMF 115. As further illustrated in FIG. 1, the LMF 120 and the UE 105 may communicate using an LTE Positioning Protocol (LPP), which may be defined in 3GPP TS 36.355. The LMF 120 and the UE 105 may also or instead communicate using a New Radio Positioning Protocol (which may be referred to as NPP or NRPP), which may be the same as, similar to, or an extension of LPP. Here, LPP and/or NPP messages may be transferred between the UE 105 and the LMF 120 via the AMF 115 and the serving gNB 110a, 110b or the serving ng-eNB 114 for the UE 105. For example, LPP and/or NPP messages may be transferred between the LMF 120 and the AMF 115 using a 5G Location Services Application Protocol (LCS AP) and may be transferred between the AMF 115 and the UE 105 using a 5G Non-Access Stratum (NAS) protocol. The LPP and/or NPP protocol may be used to support positioning of the UE 105 using UE-assisted and/or UE-based position methods such as A-GNSS, RTK, OTDOA and/or E-CID. The NRPPa protocol may be used to support positioning of the UE 105 using network-based position methods such as E-CID (e.g., when used with measurements obtained by the gNB 110a, 110b or the ng-eNB 114) and/or may be used by the LMF 120 to obtain location related information from the gNBs 110a, 110b and/or the ng-eNB 114, such as parameters defining directional SS or PRS transmissions from the gNBs 110a, 110b, and/or the ng-eNB 114. The LMF 120 may be co-located or integrated with a gNB or a TRP, or may be disposed remote from the gNB and/or the TRP and configured to communicate directly or indirectly with the gNB and/or the TRP.

With a UE-assisted position method, the UE 105 may obtain location measurements and send the measurements to a location server (e.g., the LMF 120) for computation of a location estimate for the UE 105. For example, the location measurements may include one or more of a Received Signal Strength Indication (RSSI), Round Trip signal propagation Time (RTT), Reference Signal Time Difference (RSTD), Reference Signal Received Power (RSRP) and/or Reference Signal Received Quality (RSRQ) for the gNBs 110a, 110b, the ng-eNB 114, and/or a WLAN AP. The location measurements may also or instead include measurements of GNSS pseudorange, code phase, and/or carrier phase for the SVs 190-193.

With a UE-based position method, the UE 105 may obtain location measurements (e.g., which may be the same as or similar to location measurements for a UE-assisted position method) and may compute a location of the UE 105 (e.g., with the help of assistance data received from a location server such as the LMF 120 or broadcast by the gNBs 110a, 110b, the ng-eNB 114, or other base stations or APs).

With a network-based position method, one or more base stations (e.g., the gNBs 110a, 110b, and/or the ng-eNB 114) or APs may obtain location measurements (e.g., measurements of RSSI, RTT, RSRP, RSRQ or Time of Arrival (ToA) for signals transmitted by the UE 105) and/or may receive measurements obtained by the UE 105. The one or more base stations or APs may send the measurements to a location server (e.g., the LMF 120) for computation of a location estimate for the UE 105.

Information provided by the gNBs 110a, 110b, and/or the ng-eNB 114 to the LMF 120 using NRPPa may include timing and configuration information for directional SS or PRS transmissions and location coordinates. The LMF 120 may provide some or all of this information to the UE 105 as assistance data in an LPP and/or NPP message via the NG-RAN 135 and the 5GC 140.

An LPP or NPP message sent from the LMF 120 to the UE 105 may instruct the UE 105 to do any of a variety of things depending on desired functionality. For example, the LPP or NPP message could contain an instruction for the UE 105 to obtain measurements for GNSS (or A-GNSS), WLAN, E-CID, and/or OTDOA (or some other position method). In the case of E-CID, the LPP or NPP message may instruct the UE 105 to obtain one or more measurement quantities (e.g., beam ID, beam width, mean angle, RSRP, RSRQ measurements) of directional signals transmitted within particular cells supported by one or more of the gNBs 110a, 110b, and/or the ng-eNB 114 (or supported by some other type of base station such as an eNB or WiFi® AP). The UE 105 may send the measurement quantities back to the LMF 120 in an LPP or NPP message (e.g., inside a 5G NAS message) via the serving gNB 110a (or the serving ng-eNB 114) and the AMF 115.

As noted, while the communication system 100 is described in relation to 5G technology, the communication system 100 may be implemented to support other communication technologies, such as GSM, WCDMA, LTE, etc., that are used for supporting and interacting with mobile devices such as the UE 105 (e.g., to implement voice, data, positioning, and other functionalities). In some such implementations, the 5GC 140 may be configured to control different air interfaces. For example, the 5GC 140 may be connected to a WLAN using a Non-3GPP InterWorking Function (N3IWF, not shown FIG. 1) in the 5GC 140. For example, the WLAN may support IEEE 802.11 WiFi® access for the UE 105 and may comprise one or more WiFi® APs. Here, the N3IWF may connect to the WLAN and to other elements in the 5GC 140 such as the AMF 115. In some examples, both the NG-RAN 135 and the 5GC 140 may be replaced by one or more other RANs and one or more other core networks. For example, in an EPS, the NG-RAN 135 may be replaced by an E-UTRAN containing eNBs and the 5GC 140 may be replaced by an EPC containing a Mobility Management Entity (MME) in place of the AMF 115, an E-SMLC in place of the LMF 120, and a GMLC that may be similar to the GMLC 125. In such an EPS, the E-SMLC may use LPPa in place of NRPPa to send and receive location information to and from the eNBs in the E-UTRAN and may use LPP to support positioning of the UE 105. In these other examples, positioning of the UE 105 using directional PRSs may be supported in an analogous manner to that described herein for a 5G network with the difference that functions and procedures described herein for the gNBs 110a, 110b, the ng-eNB 114, the AMF 115, and the LMF 120 may, in some cases, apply instead to other network elements such eNBs, WiFi® APs, an MME, and an E-SMLC.

As noted, in some examples, positioning functionality may be implemented, at least in part, using the directional SS or PRS beams, sent by base stations (such as the gNBs 110a, 110b, and/or the ng-eNB 114) that are within range of the UE whose position is to be determined (e.g., the UE 105 of FIG. 1). The UE may, in some instances, use the directional SS or PRS beams from a plurality of base stations (such as the gNBs 110a, 110b, the ng-eNB 114, etc.) to compute the position of the UE.

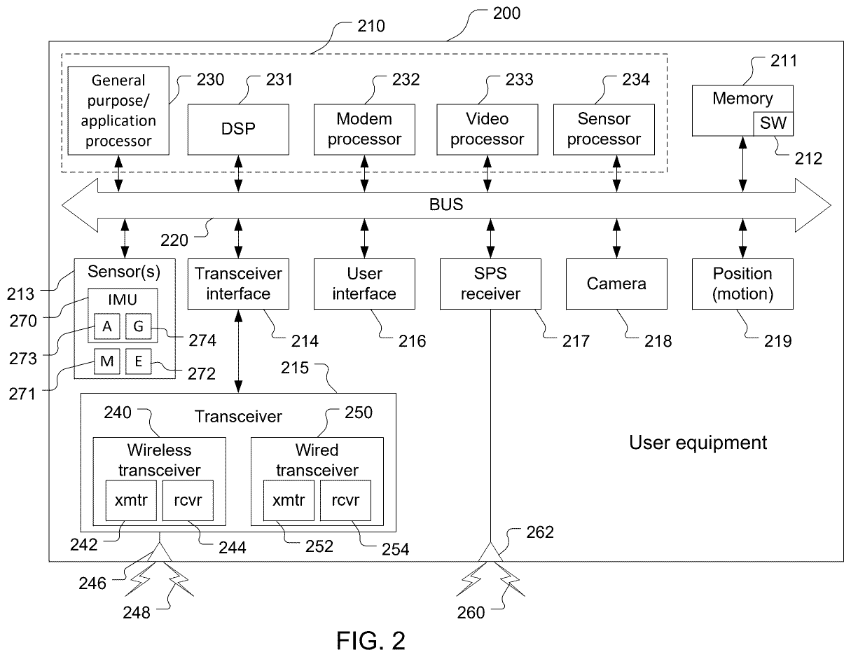

Referring also to FIG. 2, a UE 200 may be an example of one of the UEs 105, 106 and may comprise a computing platform including a processor 210, memory 211 including software (SW) 212, one or more sensors 213, a transceiver interface 214 for a transceiver 215 (that includes a wireless transceiver 240 and a wired transceiver 250), a user interface 216, a Satellite Positioning System (SPS) receiver 217, a camera 218, and a position device (PD) 219. The processor 210, the memory 211, the sensor(s) 213, the transceiver interface 214, the user interface 216, the SPS receiver 217, the camera 218, and the position device 219 may be communicatively coupled to each other by a bus 220 (which may be configured, e.g., for optical and/or electrical communication). One or more of the shown apparatus (e.g., the camera 218, the position device 219, and/or one or more of the sensor(s) 213, etc.) may be omitted from the UE 200. The processor 210 may include one or more hardware devices, e.g., a central processing unit (CPU), a microcontroller, an application specific integrated circuit (ASIC), etc. The processor 210 may comprise multiple processors including a general-purpose/application processor 230, a Digital Signal Processor (DSP) 231, a modem processor 232, a video processor 233, and/or a sensor processor 234. One or more of the processors 230-234 may comprise multiple devices (e.g., multiple processors). For example, the sensor processor 234 may comprise, e.g., processors for RF (radio frequency) sensing (with one or more (cellular) wireless signals transmitted and reflection(s) used to identify, map, and/or track an object), and/or ultrasound, etc. The modem processor 232 may support dual SIM/dual connectivity (or even more SIMs). For example, a SIM (Subscriber Identity Module or Subscriber Identification Module) may be used by an Original Equipment Manufacturer (OEM), and another SIM may be used by an end user of the UE 200 for connectivity. The memory 211 may be a non-transitory, processor-readable storage medium that may include random access memory (RAM), flash memory, disc memory, and/or read-only memory (ROM), etc. The memory 211 may store the software 212 which may be processor-readable, processor-executable software code containing instructions that may be configured to, when executed, cause the processor 210 to perform various functions described herein. Alternatively, the software 212 may not be directly executable by the processor 210 but may be configured to cause the processor 210, e.g., when compiled and executed, to perform the functions. The description herein may refer to the processor 210 performing a function, but this includes other implementations such as where the processor 210 executes instructions of software and/or firmware. The description herein may refer to the processor 210 performing a function as shorthand for one or more of the processors 230-234 performing the function. The description herein may refer to the UE 200 performing a function as shorthand for one or more appropriate components of the UE 200 performing the function. The processor 210 may include a memory with stored instructions in addition to and/or instead of the memory 211. Functionality of the processor 210 is discussed more fully below.

The configuration of the UE 200 shown in FIG. 2 is an example and not limiting of the disclosure, including the claims, and other configurations may be used. For example, an example configuration of the UE may include one or more of the processors 230-234 of the processor 210, the memory 211, and the wireless transceiver 240. Other example configurations may include one or more of the processors 230-234 of the processor 210, the memory 211, a wireless transceiver, and one or more of the sensor(s) 213, the user interface 216, the SPS receiver 217, the camera 218, the PD 219, and/or a wired transceiver.

The UE 200 may comprise the modem processor 232 that may be capable of performing baseband processing of signals received and down-converted by the transceiver 215 and/or the SPS receiver 217. The modem processor 232 may perform baseband processing of signals to be upconverted for transmission by the transceiver 215. Also or alternatively, baseband processing may be performed by the general-purpose/application processor 230 and/or the DSP 231. Other configurations, however, may be used to perform baseband processing.

The UE 200 may include the sensor(s) 213 that may include, for example, an Inertial Measurement Unit (IMU) 270, one or more magnetometers 271, and/or one or more environment sensors 272. The IMU 270 may comprise, for example, one or more accelerometers 273 (e.g., collectively responding to acceleration of the UE 200 in three dimensions) and/or one or more gyroscopes 274 (e.g., three-dimensional gyroscope(s)). The sensor(s) 213 may include the one or more magnetometers 271 (e.g., three-dimensional magnetometer(s)) to determine orientation (e.g., relative to magnetic north and/or true north) that may be used for any of a variety of purposes, e.g., to support one or more compass applications. The environment sensor(s) 272 may comprise, for example, one or more temperature sensors, one or more barometric pressure sensors, one or more ambient light sensors, one or more camera imagers, and/or one or more microphones, etc. The sensor(s) 213 may generate analog and/or digital signals indications of which may be stored in the memory 211 and processed by the DSP 231 and/or the general-purpose/application processor 230 in support of one or more applications such as, for example, applications directed to positioning and/or navigation operations. The sensor(s) 213 may comprise one or more of other various types of sensors such as one or more optical sensors, one or more weight sensors, and/or one or more radio frequency (RF) sensors, etc.

The sensor(s) 213 may be used in relative location measurements, relative location determination, motion determination, etc. Information detected by the sensor(s) 213 may be used for motion detection, relative displacement, dead reckoning, sensor-based location determination, and/or sensor-assisted location determination. The sensor(s) 213 may be useful to determine whether the UE 200 is fixed (stationary) or mobile and/or whether to report certain useful information to the LMF 120 regarding the mobility of the UE 200. For example, based on the information obtained/measured by the sensor(s) 213, the UE 200 may notify/report to the LMF 120 that the UE 200 has detected movements or that the UE 200 has moved, and may report the relative displacement/distance (e.g., via dead reckoning, or sensor-based location determination, or sensor-assisted location determination enabled by the sensor(s) 213). In another example, for relative positioning information, the sensors/IMU may be used to determine the angle and/or orientation of the other device with respect to the UE 200, etc.

The IMU 270 may be configured to provide measurements about a direction of motion and/or a speed of motion of the UE 200, which may be used in relative location determination. For example, the one or more accelerometers 273 and/or the one or more gyroscopes 274 of the IMU 270 may detect, respectively, a linear acceleration and a speed of rotation of the UE 200. The linear acceleration and speed of rotation measurements of the UE 200 may be integrated over time to determine an instantaneous direction of motion as well as a displacement of the UE 200. The instantaneous direction of motion and the displacement may be integrated to track a location of the UE 200. For example, a reference location of the UE 200 may be determined, e.g., using the SPS receiver 217 (and/or by some other means) for a moment in time and measurements from the accelerometer(s) 273 and the gyroscope(s) 274 taken after this moment in time may be used in dead reckoning to determine present location of the UE 200 based on movement (direction and distance) of the UE 200 relative to the reference location.

The magnetometer(s) 271 may determine magnetic field strengths in different directions which may be used to determine orientation of the UE 200. For example, the orientation may be used to provide a digital compass for the UE 200. The magnetometer(s) may include a two-dimensional magnetometer configured to detect and provide indications of magnetic field strength in two orthogonal dimensions. The magnetometer(s) 271 may include a three-dimensional magnetometer configured to detect and provide indications of magnetic field strength in three orthogonal dimensions. The magnetometer(s) 271 may provide means for sensing a magnetic field and providing indications of the magnetic field, e.g., to the processor 210.

The transceiver 215 may include a wireless transceiver 240 and a wired transceiver 250 configured to communicate with other devices through wireless connections and wired connections, respectively. For example, the wireless transceiver 240 may include a wireless transmitter 242 and a wireless receiver 244 coupled to an antenna 246 for transmitting (e.g., on one or more uplink channels and/or one or more sidelink channels) and/or receiving (e.g., on one or more downlink channels and/or one or more sidelink channels) wireless signals 248 and transducing signals from the wireless signals 248 to guided (e.g., wired electrical and/or optical) signals and from guided (e.g., wired electrical and/or optical) signals to the wireless signals 248. The wireless transmitter 242 includes appropriate components (e.g., a power amplifier and a digital-to-analog converter). The wireless receiver 244 includes appropriate components (e.g., one or more amplifiers, one or more frequency filters, and an analog-to-digital converter). The wireless transmitter 242 may include multiple transmitters that may be discrete components or combined/integrated components, and/or the wireless receiver 244 may include multiple receivers that may be discrete components or combined/integrated components. The wireless transceiver 240 may be configured to communicate signals (e.g., with TRPs and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long Term Evolution), LTE Direct (LTE-D), 3GPP LTE-V2X (PC5), IEEE 802.11 (including IEEE 802.11p), WiFi® short-range wireless communication technology, WiFi® Direct (WiFi-D), Bluetooth® short-range wireless communication technology, Zigbee® short-range wireless communication technology, etc. New Radio may use mm-wave frequencies and/or sub-6GHz frequencies. The wired transceiver 250 may include a wired transmitter 252 and a wired receiver 254 configured for wired communication, e.g., a network interface that may be utilized to communicate with the NG-RAN 135 to send communications to, and receive communications from, the NG-RAN 135. The wired transmitter 252 may include multiple transmitters that may be discrete components or combined/integrated components, and/or the wired receiver 254 may include multiple receivers that may be discrete components or combined/integrated components. The wired transceiver 250 may be configured, e.g., for optical communication and/or electrical communication. The transceiver 215 may be communicatively coupled to the transceiver interface 214, e.g., by optical and/or electrical connection. The transceiver interface 214 may be at least partially integrated with the transceiver 215. The wireless transmitter 242, the wireless receiver 244, and/or the antenna 246 may include multiple transmitters, multiple receivers, and/or multiple antennas, respectively, for sending and/or receiving, respectively, appropriate signals.

The user interface 216 may comprise one or more of several devices such as, for example, a speaker, microphone, display device, vibration device, keyboard, touch screen, etc. The user interface 216 may include more than one of any of these devices. The user interface 216 may be configured to enable a user to interact with one or more applications hosted by the UE 200. For example, the user interface 216 may store indications of analog and/or digital signals in the memory 211 to be processed by DSP 231 and/or the general-purpose/application processor 230 in response to action from a user. Similarly, applications hosted on the UE 200 may store indications of analog and/or digital signals in the memory 211 to present an output signal to a user. The user interface 216 may include an audio input/output (I/O) device comprising, for example, a speaker, a microphone, digital-to-analog circuitry, analog-to-digital circuitry, an amplifier and/or gain control circuitry (including more than one of any of these devices). Other configurations of an audio I/O device may be used. Also or alternatively, the user interface 216 may comprise one or more touch sensors responsive to touching and/or pressure, e.g., on a keyboard and/or touch screen of the user interface 216.

The SPS receiver 217 (e.g., a Global Positioning System (GPS) receiver) may be capable of receiving and acquiring SPS signals 260 via an SPS antenna 262. The SPS antenna 262 is configured to transduce the SPS signals 260 from wireless signals to guided signals, e.g., wired electrical or optical signals, and may be integrated with the antenna 246. The SPS receiver 217 may be configured to process, in whole or in part, the acquired SPS signals 260 for estimating a location of the UE 200. For example, the SPS receiver 217 may be configured to determine location of the UE 200 by trilateration using the SPS signals 260. The general-purpose/application processor 230, the memory 211, the DSP 231 and/or one or more specialized processors (not shown) may be utilized to process acquired SPS signals, in whole or in part, and/or to calculate an estimated location of the UE 200, in conjunction with the SPS receiver 217. The memory 211 may store indications (e.g., measurements) of the SPS signals 260 and/or other signals (e.g., signals acquired from the wireless transceiver 240) for use in performing positioning operations. The general-purpose/application processor 230, the DSP 231, and/or one or more specialized processors, and/or the memory 211 may provide or support a location engine for use in processing measurements to estimate a location of the UE 200.

The UE 200 may include the camera 218 for capturing still or moving imagery. The camera 218 may comprise, for example, an imaging sensor (e.g., a charge coupled device or a CMOS (Complementary Metal-Oxide Semiconductor) imager), a lens, analog-to-digital circuitry, frame buffers, etc. Additional processing, conditioning, encoding, and/or compression of signals representing captured images may be performed by the general-purpose/application processor 230 and/or the DSP 231. Also or alternatively, the video processor 233 may perform conditioning, encoding, compression, and/or manipulation of signals representing captured images. The video processor 233 may decode/decompress stored image data for presentation on a display device (not shown), e.g., of the user interface 216.

The position device (PD) 219 may be configured to determine a position of the UE 200, motion of the UE 200, and/or relative position of the UE 200, and/or time. For example, the PD 219 may communicate with, and/or include some or all of, the SPS receiver 217. The PD 219 may work in conjunction with the processor 210 and the memory 211 as appropriate to perform at least a portion of one or more positioning methods, although the description herein may refer to the PD 219 being configured to perform, or performing, in accordance with the positioning method(s). The PD 219 may also or alternatively be configured to determine location of the UE 200 using terrestrial-based signals (e.g., at least some of the wireless signals 248) for trilateration, for assistance with obtaining and using the SPS signals 260, or both. The PD 219 may be configured to determine location of the UE 200 based on a cell of a serving base station (e.g., a cell center) and/or another technique such as E-CID. The PD 219 may be configured to use one or more images from the camera 218 and image recognition combined with known locations of landmarks (e.g., natural landmarks such as mountains and/or artificial landmarks such as buildings, bridges, streets, etc.) to determine location of the UE 200. The PD 219 may be configured to use one or more other techniques (e.g., relying on the UE's self-reported location (e.g., part of the UE's position beacon)) for determining the location of the UE 200, and may use a combination of techniques (e.g., SPS and terrestrial positioning signals) to determine the location of the UE 200. The PD 219 may include one or more of the sensors 213 (e.g., gyroscope(s), accelerometer(s), magnetometer(s), etc.) that may sense orientation and/or motion of the UE 200 and provide indications thereof that the processor 210 (e.g., the general-purpose/application processor 230 and/or the DSP 231) may be configured to use to determine motion (e.g., a velocity vector and/or an acceleration vector) of the UE 200. The PD 219 may be configured to provide indications of uncertainty and/or error in the determined position and/or motion. Functionality of the PD 219 may be provided in a variety of manners and/or configurations, e.g., by the general-purpose/application processor 230, the transceiver 215, the SPS receiver 217, and/or another component of the UE 200, and may be provided by hardware, software, firmware, or various combinations thereof.

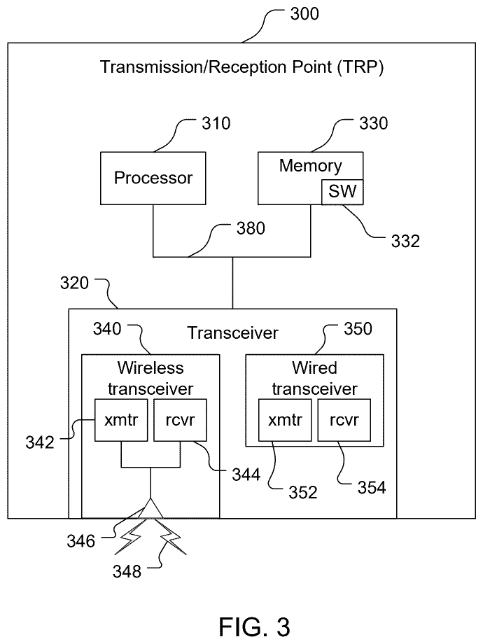

Referring also to FIG. 3, an example of a TRP 300 of the gNBs 110a, 110b and/or the ng-eNB 114 may comprise a computing platform including a processor 310, memory 330 including software (SW) 332, and a transceiver 320. Even if referred to in the singular, the processor 310 may include one or more processors, the transceiver 320 may include one or more transceivers (e.g., one or more transmitters and/or one or more receivers), and/or the memory 330 may include one or more memories. The processor 310, the memory 330, and the transceiver 320 may be communicatively coupled to each other by a bus 380 (which may be configured, e.g., for optical and/or electrical communication). One or more of the shown apparatus may be omitted from the TRP 300. The processor 310 may include one or more hardware devices, e.g., a central processing unit (CPU), a microcontroller, an application specific integrated circuit (ASIC), etc. The processor 310 may comprise multiple processors (e.g., including a general-purpose/application processor, a DSP, a modem processor, a video processor, and/or a sensor processor as shown in FIG. 2). The memory 330 may be a non-transitory storage medium that may include random access memory (RAM)), flash memory, disc memory, and/or read-only memory (ROM), etc. The memory 330 may store the software 332 which may be processor-readable, processor-executable software code containing instructions that are configured to, when executed, cause the processor 310 to perform various functions described herein. Alternatively, the software 332 may not be directly executable by the processor 310 but may be configured to cause the processor 310, e.g., when compiled and executed, to perform the functions.

The description herein may refer to the processor 310 performing a function, but this includes other implementations such as where the processor 310 executes software and/or firmware. The description herein may refer to the processor 310 performing a function as shorthand for one or more of the processors contained in the processor 310 performing the function. The description herein may refer to the TRP 300 performing a function as shorthand for one or more appropriate components (e.g., the processor 310 and the memory 330) of the TRP 300 (and thus of one of the gNBs 110a, 110b and/or the ng-eNB 114) performing the function. The processor 310 may include a memory with stored instructions in addition to and/or instead of the memory 330. Functionality of the processor 310 is discussed more fully below.

The transceiver 320 may include a wireless transceiver 340 and/or a wired transceiver 350 configured to communicate with other devices through wireless connections and wired connections, respectively. For example, the wireless transceiver 340 may include a wireless transmitter 342 and a wireless receiver 344 coupled to one or more antennas 346 for transmitting (e.g., on one or more uplink channels and/or one or more downlink channels) and/or receiving (e.g., on one or more downlink channels and/or one or more uplink channels) wireless signals 348 and transducing signals from the wireless signals 348 to guided (e.g., wired electrical and/or optical) signals and from guided (e.g., wired electrical and/or optical) signals to the wireless signals 348. Thus, the wireless transmitter 342 may include multiple transmitters that may be discrete components or combined/integrated components, and/or the wireless receiver 344 may include multiple receivers that may be discrete components or combined/integrated components. The wireless transceiver 340 may be configured to communicate signals (e.g., with the UE 200, one or more other UEs, and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long Term Evolution), LTE Direct (LTE-D), 3GPP LTE-V2X (PC5), IEEE 802.11 (including IEEE 802.11p), WiFi® short-range wireless communication technology, WiFi® Direct (WiFi-D), Bluetooth® short-range wireless communication technology, Zigbee® short-range wireless communication technology, etc. The wired transceiver 350 may include a wired transmitter 352 and a wired receiver 354 configured for wired communication, e.g., a network interface that may be utilized to communicate with the NG-RAN 135 to send communications to, and receive communications from, the LMF 120, for example, and/or one or more other network entities. The wired transmitter 352 may include multiple transmitters that may be discrete components or combined/integrated components, and/or the wired receiver 354 may include multiple receivers that may be discrete components or combined/integrated components. The wired transceiver 350 may be configured, e.g., for optical communication and/or electrical communication.

The configuration of the TRP 300 shown in FIG. 3 is an example and not limiting of the disclosure, including the claims, and other configurations may be used. For example, the description herein discusses that the TRP 300 may be configured to perform or performs several functions, but one or more of these functions may be performed by the LMF 120 and/or the UE 200 (i.e., the LMF 120 and/or the UE 200 may be configured to perform one or more of these functions).

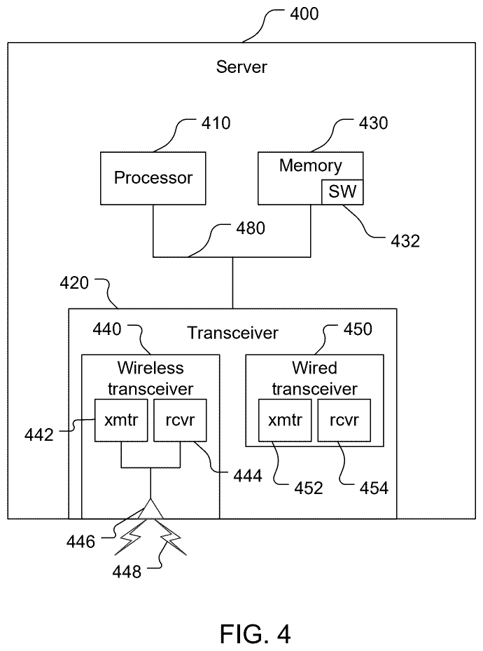

Referring also to FIG. 4, a server 400, of which the LMF 120 may be an example, may comprise a computing platform including a processor 410, memory 430 including software (SW) 432, and a transceiver 420. Even if referred to in the singular, the processor 410 may include one or more processors, the transceiver 420 may include one or more transceivers (e.g., one or more transmitters and/or one or more receivers), and/or the memory 430 may include one or more memories. The processor 410, the memory 430, and the transceiver 420 may be communicatively coupled to each other by a bus 480 (which may be configured, e.g., for optical and/or electrical communication). One or more of the shown apparatus (e.g., a wireless transceiver) may be omitted from the server 400. The processor 410 may include one or more hardware devices, e.g., a central processing unit (CPU), a microcontroller, an application specific integrated circuit (ASIC), etc. The processor 410 may comprise multiple processors (e.g., including a general-purpose/application processor, a DSP, a modem processor, a video processor, and/or a sensor processor as shown in FIG. 2). The memory 430 may be a non-transitory storage medium that may include random access memory (RAM)), flash memory, disc memory, and/or read-only memory (ROM), etc. The memory 430 may store the software 432 which may be processor-readable, processor-executable software code containing instructions that are configured to, when executed, cause the processor 410 to perform various functions described herein. Alternatively, the software 432 may not be directly executable by the processor 410 but may be configured to cause the processor 410, e.g., when compiled and executed, to perform the functions. The description herein may refer to the processor 410 performing a function, but this includes other implementations such as where the processor 410 executes software and/or firmware. The description herein may refer to the processor 410 performing a function as shorthand for one or more of the processors contained in the processor 410 performing the function. The description herein may refer to the server 400 performing a function as shorthand for one or more appropriate components of the server 400 performing the function. The processor 410 may include a memory with stored instructions in addition to and/or instead of the memory 430. Functionality of the processor 410 is discussed more fully below.

The transceiver 420 may include a wireless transceiver 440 and/or a wired transceiver 450 configured to communicate with other devices through wireless connections and wired connections, respectively. For example, the wireless transceiver 440 may include a wireless transmitter 442 and a wireless receiver 444 coupled to one or more antennas 446 for transmitting (e.g., on one or more downlink channels) and/or receiving (e.g., on one or more uplink channels) wireless signals 448 and transducing signals from the wireless signals 448 to guided (e.g., wired electrical and/or optical) signals and from guided (e.g., wired electrical and/or optical) signals to the wireless signals 448. Thus, the wireless transmitter 442 may include multiple transmitters that may be discrete components or combined/integrated components, and/or the wireless receiver 444 may include multiple receivers that may be discrete components or combined/integrated components. The wireless transceiver 440 may be configured to communicate signals (e.g., with the UE 200, one or more other UEs, and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long Term Evolution), LTE Direct (LTE-D), 3GPP LTE-V2X (PC5), IEEE 802.11 (including IEEE 802.11p), WiFi® short-range wireless communication technology, WiFi® Direct (WiFi-D), Bluetooth® short-range wireless communication technology, Zigbee® short-range wireless communication technology, etc. The wired transceiver 450 may include a wired transmitter 452 and a wired receiver 454 configured for wired communication, e.g., a network interface that may be utilized to communicate with the NG-RAN 135 to send communications to, and receive communications from, the TRP 300, for example, and/or one or more other network entities. The wired transmitter 452 may include multiple transmitters that may be discrete components or combined/integrated components, and/or the wired receiver 454 may include multiple receivers that may be discrete components or combined/integrated components. The wired transceiver 450 may be configured, e.g., for optical communication and/or electrical communication.

The configuration of the server 400 shown in FIG. 4 is an example and not limiting of the disclosure, including the claims, and other configurations may be used. For example, the wireless transceiver 440 may be omitted. Also or alternatively, the description herein discusses that the server 400 is configured to perform or performs several functions, but one or more of these functions may be performed by the TRP 300 and/or the UE 200 (i.e., the TRP 300 and/or the UE 200 may be configured to perform one or more of these functions).

### Positioning Techniques

For terrestrial positioning of a UE in cellular networks, techniques such as Advanced Forward Link Trilateration (AFLT) and Observed Time Difference Of Arrival (OTDOA) often operate in “UE-assisted” mode in which measurements of reference signals (e.g., PRS, CRS, etc.) transmitted by base stations are taken by the UE and then provided to a location server. The location server calculates the position of the UE based on the measurements and known locations of the base stations. Because these techniques use the location server to calculate the position of the UE, rather than the UE itself, these positioning techniques are not frequently used in applications such as car or cell-phone navigation, which instead typically rely on satellite-based positioning.

A UE may use a Satellite Positioning System (SPS) (a Global Navigation Satellite System (GNSS)) for high-accuracy positioning using precise point positioning (PPP) or real time kinematic (RTK) technology. These technologies use assistance data such as measurements from ground-based stations. LTE Release 15 allows the data to be encrypted so that the UEs subscribed to the service exclusively can read the information. Such assistance data varies with time. Thus, a UE subscribed to the service may not easily “break encryption” for other UEs by passing on the data to other UEs that have not paid for the subscription. The passing on would need to be repeated every time the assistance data changes.

In UE-assisted positioning, the UE sends measurements (e.g., TDOA, Angle of Arrival (AoA), etc.) to the positioning server (e.g., LMF/eSMLC). The positioning server has the base station almanac (BSA) that contains multiple ‘entries’ or ‘records’, one record per cell, where each record contains geographical cell location but also may include other data. An identifier of the ‘record’ among the multiple ‘records’ in the BSA may be referenced. The BSA and the measurements from the UE may be used to compute the position of the UE.

In conventional UE-based positioning, a UE computes its own position, thus avoiding sending measurements to the network (e.g., location server), which in turn improves latency and scalability. The UE uses relevant BSA record information (e.g., locations of gNBs (more broadly base stations)) from the network. The BSA information may be encrypted. But since the BSA information varies much less often than, for example, the PPP or RTK assistance data described earlier, it may be easier to make the BSA information (compared to the PPP or RTK information) available to UEs that did not subscribe and pay for decryption keys. Transmissions of reference signals by the gNBs make BSA information potentially accessible to crowd-sourcing or war-driving, essentially enabling BSA information to be generated based on in-the-field and/or over-the-top observations.

Positioning techniques may be characterized and/or assessed based on one or more criteria such as position determination accuracy and/or latency. Latency is a time elapsed between an event that triggers determination of position-related data and the availability of that data at a positioning system interface, e.g., an interface of the LMF 120. At initialization of a positioning system, the latency for the availability of position-related data is called time to first fix (TTFF), and is larger than latencies after the TTFF. An inverse of a time elapsed between two consecutive position-related data availabilities is called an update rate, i.e., the rate at which position-related data are generated after the first fix. Latency may depend on processing capability, e.g., of the UE. For example, a UE may report a processing capability of the UE as a duration of DL PRS symbols in units of time (e.g., milliseconds) that the UE can process every T amount of time (e.g., T ms) assuming 272 PRB (Physical Resource Block) allocation. Other examples of capabilities that may affect latency are a number of TRPs from which the UE can process PRS, a number of PRS that the UE can process, and a bandwidth of the UE.

One or more of many different positioning techniques (also called positioning methods) may be used to determine position of an entity such as one of the UEs 105, 106. For example, known position-determination techniques include RTT, multi-RTT, OTDOA (also called TDOA and including UL-TDOA and DL-TDOA), Enhanced Cell Identification (E-CID), DL-AoD, UL-AoA, etc. RTT uses a time for a signal to travel from one entity to another and back to determine a range between the two entities. The range, plus a known location of a first one of the entities and an angle between the two entities (e.g., an azimuth angle) can be used to determine a location of the second of the entities. In multi-RTT (also called multi-cell RTT), multiple ranges from one entity (e.g., a UE) to other entities (e.g., TRPs) and known locations of the other entities may be used to determine the location of the one entity. In TDOA techniques, the difference in travel times between one entity and other entities may be used to determine relative ranges from the other entities and those, combined with known locations of the other entities may be used to determine the location of the one entity. Angles of arrival and/or departure may be used to help determine location of an entity. For example, an angle of arrival or an angle of departure of a signal combined with a range between devices (determined using signal, e.g., a travel time of the signal, a received power of the signal, etc.) and a known location of one of the devices may be used to determine a location of the other device. The angle of arrival or departure may be an azimuth angle relative to a reference direction such as true north. The angle of arrival or departure may be a zenith angle relative to directly upward from an entity (i.e., relative to radially outward from a center of Earth). E-CID uses the identity of a serving cell, the timing advance (i.e., the difference between receive and transmit times at the UE), estimated timing and power of detected neighbor cell signals, and possibly angle of arrival (e.g., of a signal at the UE from the base station or vice versa) to determine location of the UE. In TDOA, the difference in arrival times at a receiving device of signals from different sources along with known locations of the sources and known offset of transmission times from the sources are used to determine the location of the receiving device.

In a network-centric RTT estimation, the serving base station instructs the UE to scan for/receive RTT measurement signals (e.g., PRS) on serving cells of two or more neighboring base stations (and typically the serving base station, as at least three base stations are needed). The one of more base stations transmit RTT measurement signals on low reuse resources (e.g., resources used by the base station to transmit system information) allocated by the network (e.g., a location server such as the LMF 120). The UE records the arrival time (also referred to as a receive time, a reception time, a time of reception, or a time of arrival (ToA)) of each RTT measurement signal relative to the UE's current downlink timing (e.g., as derived by the UE from a DL signal received from its serving base station), and transmits a common or individual RTT response message (e.g., SRS (sounding reference signal) for positioning, i.e., UL-PRS) to the one or more base stations (e.g., when instructed by its serving base station) and may include the time difference T_{Rx→Tx} (i.e., UE T_{Rx-Tx} or UE_{Rx-Tx}) between the ToA of the RTT measurement signal and the transmission time of the RTT response message in a payload of each RTT response message. The RTT response message would include a reference signal from which the base station can deduce the ToA of the RTT response. By comparing the difference T_{Tx→Rx} between the transmission time of the RTT measurement signal from the base station and the ToA of the RTT response at the base station to the UE-reported time difference T_{Rx→Tx}, and subtracting the UE_{Rx-Tx}, the base station can deduce the propagation time between the base station and the UE, from which the base station can determine the distance between the UE and the base station by assuming the speed of light during this propagation time.

A UE-centric RTT estimation is similar to the network-based method, except

that the UE transmits uplink RTT measurement signal(s) (e.g., when instructed by a serving base station), which are received by multiple base stations in the neighborhood of the UE. Each involved base station responds with a downlink RTT response message, which may include the time difference between the ToA of the RTT measurement signal at the base station and the transmission time of the RTT response message from the base station in the RTT response message payload.

For both network-centric and UE-centric procedures, the side (network or UE) that performs the RTT calculation typically (though not always) transmits the first message(s) or signal(s) (e.g., RTT measurement signal(s)), while the other side responds with one or more RTT response message(s) or signal(s) that may include the difference between the ToA of the first message(s) or signal(s) and the transmission time of the RTT response message(s) or signal(s).

A multi-RTT technique may be used to determine position. For example, a first entity (e.g., a UE) may send out one or more signals (e.g., unicast, multicast, or broadcast from the base station) and multiple second entities (e.g., other TSPs such as base station(s) and/or UE(s)) may receive a signal from the first entity and respond to this received signal. The first entity receives the responses from the multiple second entities. The first entity (or another entity such as an LMF) may use the responses from the second entities to determine ranges to the second entities and may use the multiple ranges and known locations of the second entities to determine the location of the first entity by trilateration.

In some instances, additional information may be obtained in the form of an angle of arrival (AoA) or angle of departure (AoD) that defines a straight-line direction (e.g., which may be in a horizontal plane or in three dimensions) or possibly a range of directions (e.g., for the UE from the locations of base stations). The intersection of two directions can provide another estimate of the location for the UE.

For positioning techniques using PRS (Positioning Reference Signal) signals (e.g., TDOA and RTT), PRS signals sent by multiple TRPs are measured and the arrival times of the signals, known transmission times, and known locations of the TRPs used to determine ranges from a UE to the TRPs. For example, an RSTD (Reference Signal Time Difference) may be determined for PRS signals received from multiple TRPs and used in a TDOA technique to determine position (location) of the UE. A positioning reference signal may be referred to as a PRS or a PRS signal. The PRS signals are typically sent using the same power and PRS signals with the same signal characteristics (e.g., same frequency shift) may interfere with each other such that a PRS signal from a more distant TRP may be overwhelmed by a PRS signal from a closer TRP such that the signal from the more distant TRP may not be detected. PRS muting may be used to help reduce interference by muting some PRS signals (reducing the power of the PRS signal, e.g., to zero and thus not transmitting the PRS signal). In this way, a weaker (at the UE) PRS signal may be more easily detected by the UE without a stronger PRS signal interfering with the weaker PRS signal. The term RS, and variations thereof (e.g., PRS, SRS, CSI-RS (Channel State Information-Reference Signal)), may refer to one reference signal or more than one reference signal.

Positioning reference signals (PRS) include downlink PRS (DL PRS, often referred to simply as PRS) and uplink PRS (UL PRS) (which may be called SRS (Sounding Reference Signal) for positioning). A PRS may comprise a PN code (pseudorandom number code) or be generated using a PN code (e.g., by modulating a carrier signal with the PN code) such that a source of the PRS may serve as a pseudo-satellite (a pseudolite). The PN code may be unique to the PRS source (at least within a specified area such that identical PRS from different PRS sources do not overlap). PRS may comprise PRS resources and/or PRS resource sets of a frequency layer. A DL PRS positioning frequency layer (or simply a frequency layer) is a collection of DL PRS resource sets, from one or more TRPs, with PRS resource(s) that have common parameters configured by higher-layer parameters DL-PRS-PositioningFrequencyLayer, DL-PRS-ResourceSet, and DL-PRS-Resource. Each frequency layer has a DL PRS subcarrier spacing (SCS) for the DL PRS resource sets and the DL PRS resources in the frequency layer. Each frequency layer has a DL PRS cyclic prefix (CP) for the DL PRS resource sets and the DL PRS resources in the frequency layer. In 5G, a resource block occupies 12 consecutive subcarriers and a specified number of symbols. Common resource blocks are the set of resource blocks that occupy a channel bandwidth. A bandwidth part (BWP) is a set of contiguous common resource blocks and may include all the common resource blocks within a channel bandwidth or a subset of the common resource blocks. Also, a DL PRS Point A parameter defines a frequency of a reference resource block (and the lowest subcarrier of the resource block), with DL PRS resources belonging to the same DL PRS resource set having the same Point A and all DL PRS resource sets belonging to the same frequency layer having the same Point A. A frequency layer also has the same DL PRS bandwidth, the same start PRB (and center frequency), and the same value of comb size (i.e., a frequency of PRS resource elements per symbol such that for comb-N, every N^{th} resource element is a PRS resource element). A PRS resource set is identified by a PRS resource set ID and may be associated with a particular TRP (identified by a cell ID) transmitted by an antenna panel of a base station. A PRS resource ID in a PRS resource set may be associated with an omnidirectional signal, and/or with a single beam (and/or beam ID) transmitted from a single base station (where a base station may transmit one or more beams). Each PRS resource of a PRS resource set may be transmitted on a different beam and as such, a PRS resource (or simply resource) can also be referred to as a beam. This does not have any implications on whether the base stations and the beams on which PRS are transmitted are known to the UE.

A TRP may be configured, e.g., by instructions received from a server and/or by software in the TRP, to send DL PRS per a schedule. According to the schedule, the TRP may send the DL PRS intermittently, e.g., periodically at a consistent interval from an initial transmission. The TRP may be configured to send one or more PRS resource sets. A resource set is a collection of PRS resources across one TRP, with the resources having the same periodicity, a common muting pattern configuration (if any), and the same repetition factor across slots. Each of the PRS resource sets comprises multiple PRS resources, with each PRS resource comprising multiple OFDM (Orthogonal Frequency Division Multiplexing) Resource Elements (REs) that may be in multiple Resource Blocks (RBs) within N (one or more) consecutive symbol(s) within a slot. PRS resources (or reference signal (RS) resources generally) may be referred to as OFDM PRS resources (or OFDM RS resources). An RB is a collection of REs spanning a quantity of one or more consecutive symbols in the time domain and a quantity (12 for a 5G RB) of consecutive sub-carriers in the frequency domain. Each PRS resource is configured with an RE offset, slot offset, a symbol offset within a slot, and a number of consecutive symbols that the PRS resource may occupy within a slot. The RE offset defines the starting RE offset of the first symbol within a DL PRS resource in frequency. The relative RE offsets of the remaining symbols within a DL PRS resource are defined based on the initial offset. The slot offset is the starting slot of the DL PRS resource with respect to a corresponding resource set slot offset. The symbol offset determines the starting symbol of the DL PRS resource within the starting slot. Transmitted REs may repeat across slots, with each transmission being called a repetition such that there may be multiple repetitions in a PRS resource. The DL PRS resources in a DL PRS resource set are associated with the same TRP and each DL PRS resource has a DL PRS resource ID. A DL PRS resource ID in a DL PRS resource set is associated with a single beam transmitted from a single TRP (although a TRP may transmit one or more beams).

A PRS resource may also be defined by quasi-co-location and start PRB parameters. A quasi-co-location (QCL) parameter may define any quasi-co-location information of the DL PRS resource with other reference signals. The DL PRS may be configured to be QCL type D with a DL PRS or SS/PBCH (Synchronization Signal/Physical Broadcast Channel) Block from a serving cell or a non-serving cell. The DL PRS may be configured to be QCL type C with an SS/PBCH Block from a serving cell or a non-serving cell. The start PRB parameter defines the starting PRB index of the DL PRS resource with respect to reference Point A. The starting PRB index has a granularity of one PRB and may have a minimum value of 0 and a maximum value of 2176 PRBs.

A PRS resource set is a collection of PRS resources with the same periodicity, same muting pattern configuration (if any), and the same repetition factor across slots. Every time all repetitions of all PRS resources of the PRS resource set are configured to be transmitted is referred as an “instance”. Therefore, an “instance” of a PRS resource set is a specified number of repetitions for each PRS resource and a specified number of PRS resources within the PRS resource set such that once the specified number of repetitions are transmitted for each of the specified number of PRS resources, the instance is complete. An instance may also be referred to as an “occasion.” A DL PRS configuration including a DL PRS transmission schedule may be provided to a UE to facilitate (or even enable) the UE to measure the DL PRS.

Multiple frequency layers of PRS may be aggregated to provide an effective bandwidth that is larger than any of the bandwidths of the layers individually. Multiple frequency layers of component carriers (which may be consecutive and/or separate) and meeting criteria such as being quasi co-located (QCLed), and having the same antenna port, may be stitched to provide a larger effective PRS bandwidth (for DL PRS and UL PRS) resulting in increased time of arrival measurement accuracy. Stitching comprises combining PRS measurements over individual bandwidth fragments into a unified piece such that the stitched PRS may be treated as having been taken from a single measurement. Being QCLed, the different frequency layers behave similarly, enabling stitching of the PRS to yield the larger effective bandwidth. The larger effective bandwidth, which may be referred to as the bandwidth of an aggregated PRS or the frequency bandwidth of an aggregated PRS, provides for better time-domain resolution (e.g., of TDOA). An aggregated PRS includes a collection of PRS resources and each PRS resource of an aggregated PRS may be called a PRS component, and each PRS component may be transmitted on different component carriers, bands, or frequency layers, or on different portions of the same band.

RTT positioning is an active positioning technique in that RTT uses positioning signals sent by TRPs to UEs and by UEs (that are participating in RTT positioning) to TRPs. The TRPs may send DL-PRS signals that are received by the UEs and the UEs may send SRS (Sounding Reference Signal) signals that are received by multiple TRPs. A sounding reference signal may be referred to as an SRS or an SRS signal. In 5G multi-RTT, coordinated positioning may be used with the UE sending a single UL-SRS for positioning that is received by multiple TRPs instead of sending a separate UL-SRS for positioning for each TRP. A TRP that participates in multi-RTT will typically search for UEs that are currently camped on that TRP (served UEs, with the TRP being a serving TRP) and also UEs that are camped on neighboring TRPs (neighbor UEs). Neighbor TRPs may be TRPs of a single BTS (Base Transceiver Station) (e.g., gNB), or may be a TRP of one BTS and a TRP of a separate BTS. For RTT positioning, including multi-RTT positioning, the DL-PRS signal and the UL-SRS for positioning signal in a PRS/SRS for positioning signal pair used to determine RTT (and thus used to determine range between the UE and the TRP) may occur close in time to each other such that errors due to UE motion and/or UE clock drift and/or TRP clock drift are within acceptable limits. For example, signals in a PRS/SRS for positioning signal pair may be transmitted from the TRP and the UE, respectively, within about 10 ms of each other. With SRS for positioning being sent by UEs, and with PRS and SRS for positioning being conveyed close in time to each other, it has been found that radio-frequency (RF) signal congestion may result (which may cause excessive noise, etc.) especially if many UEs attempt positioning concurrently and/or that computational congestion may result at the TRPs that are trying to measure many UEs concurrently.

RTT positioning may be UE-based or UE-assisted. In UE-based RTT, the UE 200 determines the RTT and corresponding range to each of the TRPs 300 and the position of the UE 200 based on the ranges to the TRPs 300 and known locations of the TRPs 300. In UE-assisted RTT, the UE 200 measures positioning signals and provides measurement information to the TRP 300, and the TRP 300 determines the RTT and range. The TRP 300 provides ranges to a location server, e.g., the server 400, and the server determines the location of the UE 200, e.g., based on ranges to different TRPs 300. The RTT and/or range may be determined by the TRP 300 that received the signal(s) from the UE 200, by this TRP 300 in combination with one or more other devices, e.g., one or more other TRPs 300 and/or the server 400, or by one or more devices other than the TRP 300 that received the signal(s) from the UE 200.

Various positioning techniques are supported in 5G NR. The NR native positioning methods supported in 5G NR include DL-only positioning methods, UL-only positioning methods, and DL+UL positioning methods. Downlink-based positioning methods include DL-TDOA and DL-AoD. Uplink-based positioning methods include UL-TDOA and UL-AoA. Combined DL+UL-based positioning methods include RTT with one base station and RTT with multiple base stations (multi-RTT).

A position estimate (e.g., for a UE) may be referred to by other names, such as a location estimate, location, position, position fix, fix, or the like. A position estimate may be geodetic and comprise coordinates (e.g., latitude, longitude, and possibly altitude) or may be civic and comprise a street address, postal address, or some other verbal description of a location. A position estimate may further be defined relative to some other known location or defined in absolute terms (e.g., using latitude, longitude, and possibly altitude). A position estimate may include an expected error or uncertainty (e.g., by including an area or volume within which the location is expected to be included with some specified or default level of confidence). Position information may include one or more positioning signal measurements (e.g., of one or more satellite signals, of PRS, and/or one or more other signals), and/or one or more values (e.g., one or more ranges (possibly including one or more pseudoranges), and/or one or more position estimates, etc.) based on one or more positioning signal measurements.

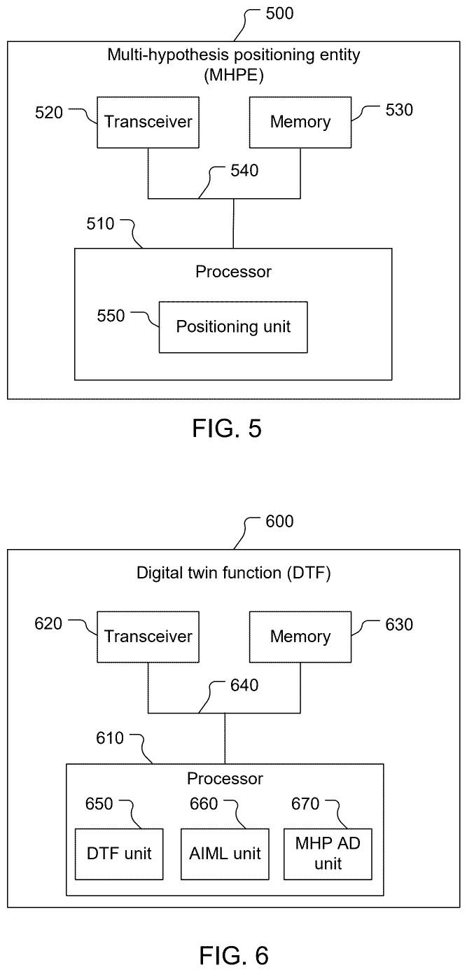

Referring also to FIG. 5, an MHPE 500 (Multi-Hypothesis Positioning Entity) includes a processor 510, a transceiver 520, and a memory 530 communicatively coupled to each other by a bus 540. Even if referred to in the singular, the processor 510 may include one or more processors, the transceiver 520 may include one or more transceivers (e.g., one or more transmitters and/or one or more receivers), and/or the memory 530 may include one or more memories. The MHPE 500 may be any of a variety of entities, e.g., a UE, a positioning reference unit (PRU), an LMF (e.g., the server 400), etc. The MHPE 500 may include the components shown in FIG. 5. The MHPE 500 may include one or more other components such as any of those shown in FIG. 2 such that the UE 200 may be an example of the MHPE 500. For example, the processor 510 may include one or more of the components of the processor 210. The transceiver 520 may include one or more of the components of the transceiver 215, e.g., the wireless transmitter 242 and the antenna 246, or the wireless receiver 244 and the antenna 246, or the wireless transmitter 242, the wireless receiver 244, and the antenna 246. Also or alternatively, the transceiver 520 may include the wired transmitter 252 and/or the wired receiver 254. The memory 530 may be configured similarly to the memory 211, e.g., including software with processor-readable instructions configured to cause the processor 510 to perform functions.

The description herein may refer to the processor 510 performing a function, but this includes other implementations such as where the processor 510 executes software (stored in the memory 530) and/or firmware. The description herein may refer to the MHPE 500 performing a function as shorthand for one or more appropriate components (e.g., the processor 510 and the memory 530) of the MHPE 500 performing the function. The processor 510 (possibly in conjunction with the memory 530 and, as appropriate, the transceiver 520) may include a positioning unit 550. The positioning unit 550 may be configured to perform positioning operations (e.g., determine position information (e.g., measurements, pseudoranges, position estimates, etc.)) based on multiple hypotheses of positioning signal receipt timing and possibly distribution. The positioning unit 550 is discussed further below, and the description may refer to the processor 510 generally, or the MHPE 500 generally, as performing any of the functions of the positioning unit 550, with the MHPE 500 being configured to perform the function(s).

Referring also to FIG. 6, a DTF 600 (Digital Twin Function, also called a Digital Twin management Function (DTmF)) includes a processor 610, a transceiver 620, and a memory 630 communicatively coupled to each other by a bus 640. Even if referred to in the singular, the DTF 600 may include one or more network entities, the processor 610 may include one or more processors, the transceiver 620 may include one or more transceivers (e.g., one or more transmitters and/or one or more receivers), and/or the memory 630 may include one or more memories. The DTF 600 may be configured to manage digital-twin-related operations. The DTF 600 may be any of a variety of entities, e.g., a core-network entity, an LMF, an NWDAF (Network Data Analytic Function), an O-RAN entity (Open Radio Access Network entity) (e.g., an SMO (Service Management and Orchestration)), a UE, a PRU, a gNB (or other base station/TRP), an OAM (Operation And Management) entity, etc. The DTF 600 may include the components shown in FIG. 6 and may be configured to be a component of a communication network (e.g., a terrestrial communication network such as a cellular network). The DTF 600 may include one or more other components such as any of those shown in FIG. 4 such that the server 400 may be an example of the DTF 600 or the DTF 600 may be part of the server 400. For example, the processor 610 may include one or more of the components of the processor 410. The transceiver 620 may include one or more of the components of the transceiver 420. The memory 630 may be configured similarly to the memory 430, e.g., including software with processor-readable instructions configured to cause the processor 610 to perform functions. Also or alternatively, the DTF 600 may include one or more other components such as any of those shown in FIG. 3 such that the TRP 300 may be an example of the DTF 600 or the DTF 600 may be part of the TRP 300. For example, the processor 610 may include one or more of the components of the processor 310. The transceiver 620 may include one or more of the components of the transceiver 320. The memory 630 may be configured similarly to the memory 330, e.g., including software with processor-readable instructions configured to cause the processor 610 to perform functions. As another example, the DTF 600 may include components shown in FIG. 2, with the UE 200 being an example of the DTF 600 or the DTF 600 being a part of the UE 200.

The description herein may refer to the processor 610 performing a function, but this includes other implementations such as where the processor 610 executes software (stored in the memory 630) and/or firmware. The description herein may refer to the DTF 600 performing a function as shorthand for one or more appropriate components (e.g., the processor 610 and the memory 630) of the DTF 600 performing the function. The processor 610 (possibly in conjunction with the memory 630 and, as appropriate, the transceiver 620) may include a DTF unit 650, an AIML unit 660 (Artificial Intelligence/Machine Learning unit), and an MHP unit 670 (Multi-Hypothesis Positioning unit). The units 650, 660, 670 are discussed further below, and the description may refer to the processor 610 generally, or the DTF 600 generally, as performing any of the functions of the units 650, 660, 670, with the DTF 600 being configured to perform the function(s).

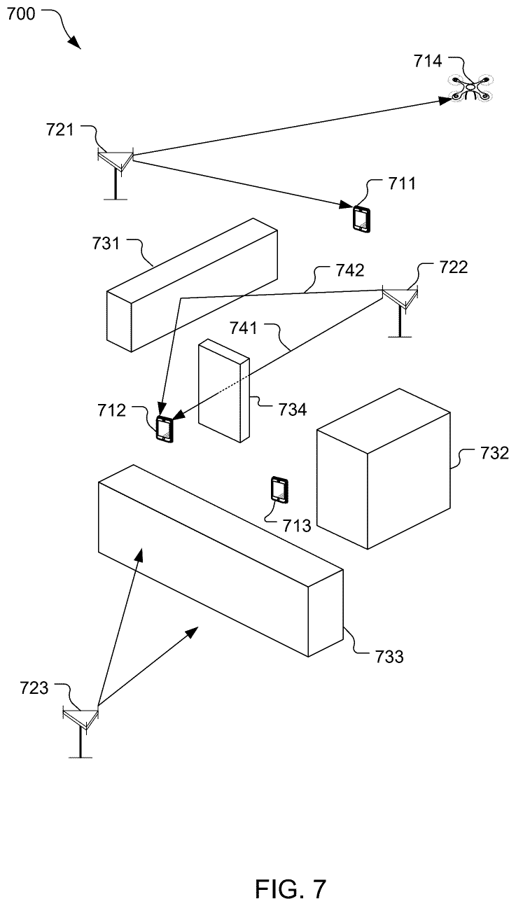

Referring also to FIG. 7, an environment 700 containing multiple mobile devices 711, 712, 713, 714 for which locations (also known as location estimates, positions, and/or position estimates) may be desired to be known/determined. In the environment, there are multiple TRPs 721, 722, 723 and multiple objects 731, 732, 733, 734 that present potential obstructions between TRPs and mobile devices. In the example environment 700, the mobile devices 711-713 are mobile phones, the mobile device 714 is an unoccupied aerial vehicle (UAV), the objects 731-733 are buildings, and the object 734 is a wall. The presence of the objects 731-734 in the environment 700 may result in the environment 700 being a challenging environment for positioning, with multipath signaling between one or more of the TRPs 721-723 and one or more of the mobile devices 711-714. For example, a signal transmitted from the TRP 722 may take a direct path 741 (LOS path (line-of-sight path)) and a reflected path 742 to reach the mobile device 712.

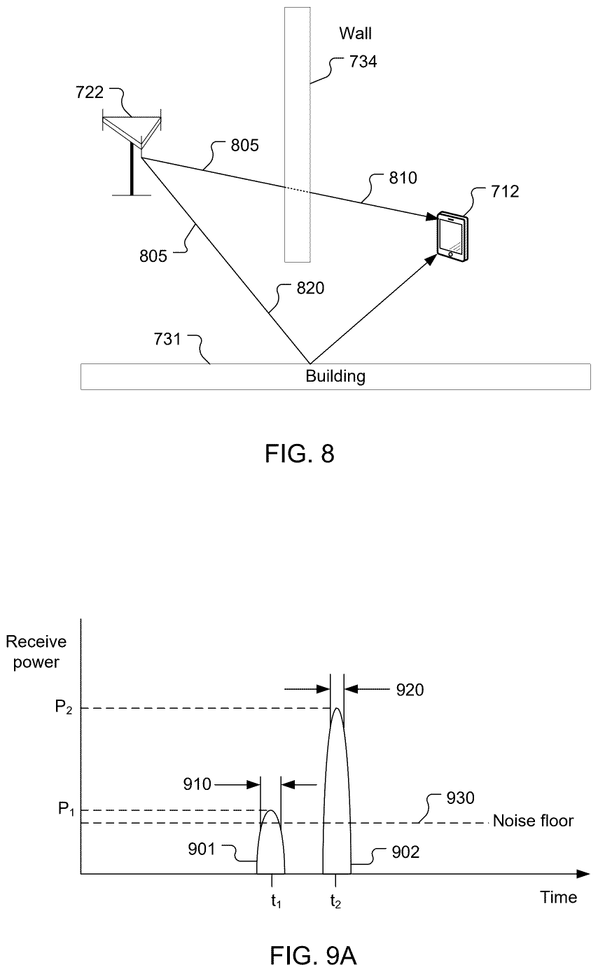

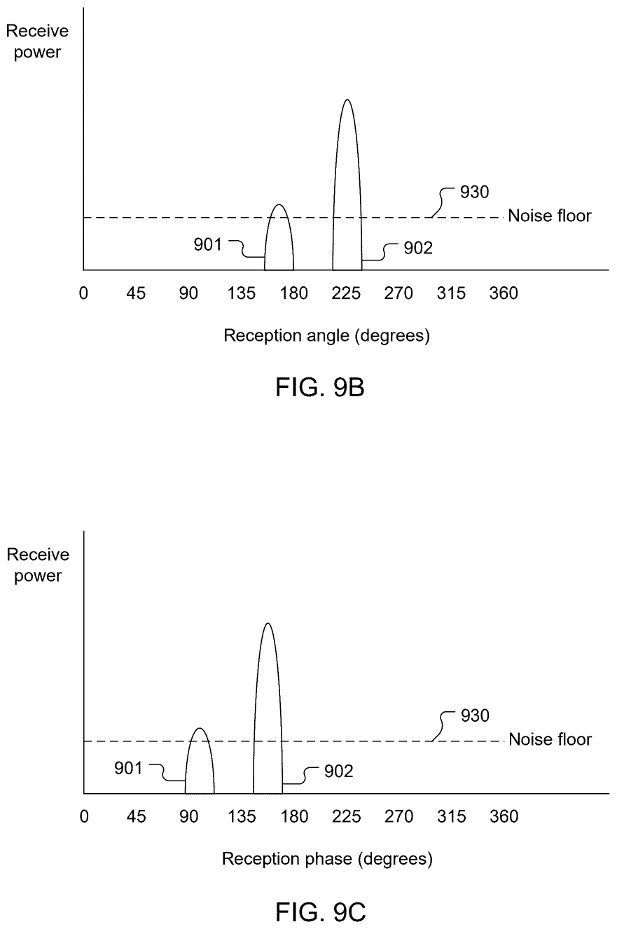

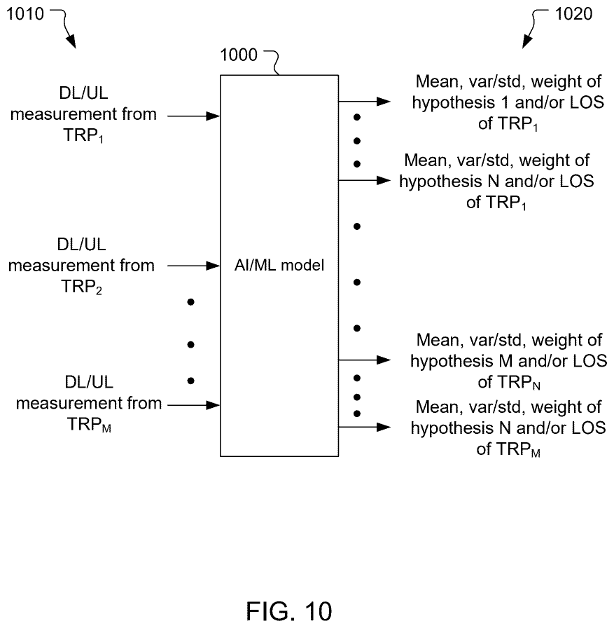

Referring also to FIG. 8 and FIG. 9A, an example of multipath signaling between the TRP 722 and the mobile device 712 is shown. In this example, a signal 805 is transmitted by the TRP 722 directly toward the mobile device 712 along an LOS path 810 (line-of-sight path). The signal 805 on the LOS path 810 passes through the object 734 (a wall) and is received by the mobile device 712. While the signal 805 travels along the LOS path 810, because the TRP 722 does not have line of sight with the mobile device 712, the signal 805 on the LOS path 810 is attenuated before being received by the mobile device 712. The signal 805 from the TRP 722 also travels along a reflection path 820 from the TRP 722 toward the object 731, with the signal 805 being reflected by the object 731, and received by the mobile device 712. The signal 805 on the path 820 is received later than the signal 805 on the LOS path 810 by the mobile device 712 because the signal 805 travels further on the path 820 than on the LOS path 810 to reach the mobile device 712. Although the signal 805 on the reflected path 820 may be attenuated slightly due to reflection from the object 731, the signal 805 on the path 820 will likely have a much higher power than the signal 805 on the path 810 when received by the mobile device 712. Thus, as shown in FIG. 9A, the signal 805 on the path 810 arrives at the mobile device 712 at a time t₁ (corresponding to a power peak 901 of the signal 805 from the path 810) that is earlier than a time t₂ (corresponding to a power peak 902 of the signal 805 from the path 820) at which the signal 805 on the path 820 arrives at the mobile device 712. Also, the signal 805 on the LOS path 810 arrives with a lower peak power P₁ than a peak power P₂ of the signal 805 received from the path 820. The power of the signal 805 received as shown in FIG. 9A is not received at single points in time, but rather is distributed over respective power distributions. The respective power distributions may be estimated by one or more mathematical distributions, e.g., Gaussian distributions. The reception of the signal 805 on the LOS path 810 that is weaker than the reception of the signal 805 on the path 820 (here, slightly above a noise floor 930) may confuse an entity attempting to determine an arrival time of a positioning signal at the mobile device 712. Thus, rather than reporting one arrival time hypothesis (e.g., the time t₁ or the time t₂), multiple hypotheses of arrival time may be determined and reported, and a distribution of possible times may be determined and reported for each hypothesis. Characteristics of each of the signal distributions include a distribution type (e.g., Gaussian), a tap width 910, 920 (e.g., a time spread of a level 3 dB down from the peak power P₁, P₂), time or arrival corresponding to the peak power (t₁, t₂), and the peak power.

Multiple hypotheses of positioning information based on signal timing may be determined and used for positioning. For example, multiple hypotheses of signal arrival time, e.g., as discussed with respect to FIG. 9A, may be used for range determination for positioning. As another example, multiple hypotheses of signal transmission times and/or signal reception times may be used to determine multiple hypotheses for RTT measurements for a path, which may be used for determine range between devices for positioning of a target device. As another example, multiple hypotheses of signal transmission times and/or signal reception times may be used to determine multiple hypotheses for RTT measurements for each of multiple paths between a transmitter and a receiver, which may be used for determine range between devices for positioning of a target device.

Multiple hypotheses of one or more signal measurements other than timing measurements may also or alternatively be determined and used to as part of multi-hypothesis positioning to determine position of a target device. For example, multiple hypotheses of receive power may be determined, e.g., for one or more signal arrivals, e.g., each signal arrival with power exceeding the noise floor 930 such as the power peaks 901, 902 shown in FIG. 9A. Multiple power hypotheses may be may for a “single” power peak, e.g., where paths of very similar lengths result in very close signal arrivals resulting in a wide power peak. As another example, referring also to FIG. 9B, multiple hypotheses of angle of arrival (AoA) and/or angle of departure (AoD) may be may for each of one or more signals, and each of one or more paths for one or more of the signals, transferred between a transmitter and a receiver (which may be the same device due to reflected signal(s)) and (for received signals) with a received power above the noise floor 930. As another example, referring also to FIG. 9C, multiple hypotheses of signal phase may be may for each of one or more signals, and each of one or more paths for one or more of the signals, transferred between a transmitter and a receiver and (for received signals) with a received power above the noise floor 930. As another example, for each of one or more signals, multiple hypotheses may be made as to whether a signal is an LOS or an NLOS signal between the transmitter and the receiver. The multiple hypotheses for each of the one or more pieces of positioning information may be used to determine a position of a target device as part of multi-hypothesis positioning.

Referring also to FIG. 10, an AIML model 1000 may be used to determine soft information from positioning signal measurements. Soft information may comprise one or more quality metrics of uncertain measurement quantities (as opposed to hard information that comprises finite values of measurement quantities). The soft information can also be represented or associated with a value between 0 and 1, e.g., probability or confidence, or value between 1 and 100, e.g., percentage. The AIML model 1000 may be implemented, for example, by the AIML positioning unit 550 of the MHPE 500. The AIML model 1000 may receive input 1010 comprising downlink (DL) and/or uplink (UL) measurement information corresponding to each of up to M TRPs. The input 1010 may be, for example, a PRS or SRS measurement expressed as CIR/PDP/DP (Channel Impulse Response that includes timing, power/magnitude, and phase/angle of a time-domain channel response). The AIML model 1000 can use the input 1010 to produce output 1020 comprising soft-information about up to N hypotheses for each of the up to M TRPs. The output 1020 may comprise, e.g., a mean, variation/standard deviation, and/or weight for each hypothesis of a distribution function of information (e.g., ToA, RSTD, AoD, AoA, LOS/NLOS (line of sight/non line of sight) of a received signal corresponding to each TRP. For positioning, the AIML model 1000 may be evaluated and the model output reported.

AIML positioning can show excellent positioning accuracy in stringent NLOS conditions. Traditional positioning techniques may not yield sufficient accuracy in NLOS conditions. Information such as LOS, timing information, and/or angle information as hard information or soft information can be reported (for AIML and/or non-AIML positioning). Soft information may be reported as multiple-hypotheses of probability distributions. For example, an RSTD measurement of a first path may be expressed as a mixture of Gaussian distributions in which each distribution is represented by a tuple of mean, var/std (variation/standard deviation), and weight. The MHPE 500 (e.g., the positioning unit 550) may apply likelihood fusion using the multi-hypothesis probability distributions for positioning, e.g. to use probability distributions to reduce error in positioning solutions. A feasibility of using multi-hypothesis positioning (MHP), the condition(s) corresponding to the feasibility, a viable (or even optimal) number of hypotheses to use, and/or a viable (or even optimal) probability distribution to use for MHP may be scenario dependent. Thus, the feasibility, condition(s), number of hypotheses, and/or probability distribution may be selected based on a scenario, e.g., to reduce overhead of reporting irrelevant MHP measurements.

A digital twin approach is discussed herein for multi-hypothesis positioning and reporting, e.g., to produce and use MHP assistance data (AD) and to determine configurations for MHP. For example, a digital twin may be used to determine whether, and under what condition(s), using MHP will improve positioning accuracy and/or yield acceptable positioning accuracy. A digital twin may be used to determine information for use in implementing MHP, e.g., what parameters to be used, a number of hypotheses to use, a probability distribution type to use, etc.

A digital twin (DT) may be a digital replica of an existing entity in the real world that characterizes and models the behavior, interactions, state, and/or evolution over time of the existing entity. A DT may be constructed, e.g., by the DTF unit 650, for a wireless channel (e.g., DT channel and DT RAN (including radios and transmitted waveforms)). For example, ray tracing (RT) may be used to model the DT by modeling radio propagations to predict outcomes of signal transmission and reception. For example, ray tracing may be used to model a channel between the TRP 722 and the mobile device 712 as shown in FIG. 7 and FIG. 8, e.g., tracing rays corresponding to paths 810, 820.

Simulation of radio propagation using ray tracing may be performed in stages. In a first stage, a model environment may be constructed based on a CAD model (Computer-Aided Design model)/map model, camera data, lidar and/or radar measurements, sensor measurements (e.g., IMU measurements, barometric measurements, etc.), RF measurements, and/or network status and/or events, etc. The model environment may comprise, e.g., a 2D model, 3D model, a radio model, a network model, and/or a traffic/application model. The model may include various characteristics, e.g., materials (permittivity, conductivity), Tx and Rx locations, mobility, waveforms, antennas (type(s) and location(s)), number of reflections, number of penetrations, number of diffractions, scattering parameters, power, etc. In a second stage, possible paths are found and validated between Tx and Rx points using a ray-tracing method, e.g., a shoot-and-bounce ray (SBR) method, an image method (IM), and/or one or more hybrid methods. In a third stage, with the model and paths established, electromagnetic (EM) calculations may be performed to determine EM fields for valid rays (e.g., using high-frequency asymptotic techniques), e.g., using geometric optics (GO), uniform asymptotic theory (UAT), geometric theory of diffraction (GTD), uniform theory of diffraction (UTD), physical optics, one or more spectral methods, multi-edge diffraction (e.g., Deygout model, Epstein-Peterson model, etc.), Lambertian scattering, directive scattering, directive backscattering, and/or multiple scattering theory, etc.

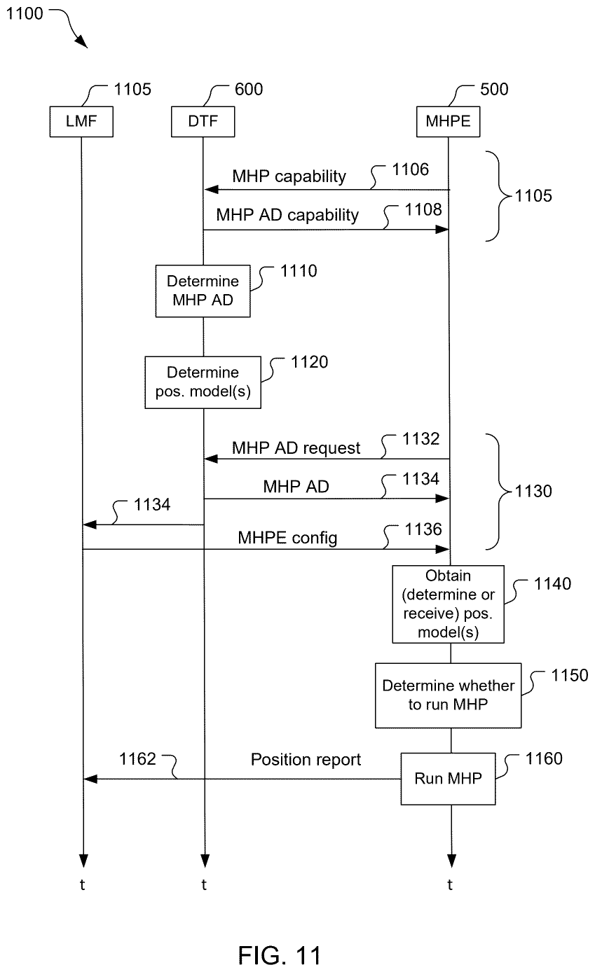

Referring also to FIG. 11, a signal and processing flow 1100 for determining and using a digital twin to provide multi-hypothesis positioning assistance data (MHP AD), and using the MHP AD to determine a position estimate for a mobile device includes stages shown. The flow 1100 is an example flow and not limiting. The flow 1100 may be altered, e.g., by having one or more messages and/or one or more stages added, removed, rearranged, combined, performed concurrently, and/or having one or more messages and/or one or more stages split into multiple messages and/or stages.

At stage 1105, the DTF 600 and/or the MHPE 500 may transmit respective capability messages regarding MHP AD and MHP. For example, the MHPE 500 may transmit (e.g., broadcast or point to point) an MHP capability message 1106 to the DTF 600 indicating a capability of the MHPE to (e.g., whether or that the MHPE 500 can) perform MHP, and possibly that the MHPE 500 can process MHP AD (and possibly what MHP AD that the MHPE 500 can process) in order to perform MHP. The DTF 600 may transmit (e.g., broadcast) an MHP AD capability message 1108 to the MHPE 500 indicating that the DTF 600 can provide MHP AD (and possibly what MHP AD the DTF 600 can provide). The DTF 600 may transmit the MHP AD capability message 1108 based on or in response to receiving (e.g., only if the DTF 600 receives) the MHP capability message 1106. Alternatively, the MHPE 500 may transmit the MHP capability message 1106 based on or in response to receiving (e.g., only if the MHPE 500 receives) the MHP AD capability message 1108. Thus, the timing order of the messages 1106, 1108 shown in FIG. 11 is an example, and the order may be reversed.

At stage 1110, the DTF 600, e.g., the MHP AD unit 670, determines MHP AD. For example, the MHP AD unit 670 determines a digital twin, e.g., using ray tracing and/or an AIML approach, e.g., as discussed herein. Using the digital twin, the MHP AD unit 670 may determine MHP AD corresponding to the digital twin by evaluating EM fields for the digital twin. The MHP AD unit 670 may evaluate various scenarios to determine assistance data for the scenarios. A scenario may include an area (in which a mobile device may be disposed) (e.g., using cell ID(s) and/or geographical description (e.g., using latitude, longitude, elevation)), and/or a mobile device status/situation (called a scenario status) (e.g., outdoors (e.g., rural, suburban, urban, micro urban, dense urban, downtown, urban canyon, etc.), indoors (e.g., residential, office, shopping mall, factory, etc.), vehicle (e.g., driving on a highway, driving on a main street, driving on a side street, etc.), aerial (e.g., a UAV (Unoccupied Aerial Vehicle) route)), etc.). The MHP AD (also called DT outcomes) may include feasibility of using MHP, one or more MHP parameters (including the value(s) of the parameter(s)), one or more conditions (e.g., for using MHP, or preferring to use MHP, or for not using MHP, such as radio conditions to be monitored/measured), and/or information for use in determining one or more MHP parameters (e.g., number of hypotheses to use). The DTF 600 may determine the MHP AD based on having received (e.g., only if the DTF 600 has received) the MHP capability message 1106 from at least one MHPE 500.

The MHP AD unit 670 may determine feasibility of using MHP as part of the MHP AD. For example, the MHP AD unit 670 may determine, e.g., for an area and scenario, that using MHP is feasible and recommended (e.g., because using MHP will likely yield a more accurate position estimate than not using MHP). As another example, the MHP AD unit 670 may determine that using MHP is feasible but will have comparable performance to single-hypothesis positioning (e.g., will likely yield a position estimate accuracy within a threshold accuracy of single-hypothesis positioning). As another example, the MHP AD unit 670 may determine that using MHP is not feasible or feasible, but not recommended (e.g., because using MHP will not yield a position estimate accuracy within a threshold accuracy of using single-hypothesis positioning). For example, if a mobile device whose position estimate is to be determined is driving on a highway, then MHP may not be recommended because there is a high likelihood of LOS to multiple TRPs.

The MHP AD unit 670 may determine one or more MHP parameters for using MHP as part of the MHP AD. For example, the MHP AD may include a recommended (e.g., preferred) quantity of hypotheses to use. For example, in a particular scenario, M paths may be expected between a Tx source and a receiver, and thus M hypotheses may be recommended to be considered. If paths are not close (e.g., in length (and thus expected signal arrival time) and/or attenuation), then fewer hypotheses than the number of expected paths may be recommended to be considered. As another example, the MHP AD may include one or more recommended probability distributions (e.g., Gaussian, exponential, Rayleigh, Weibull, Chi-Square, Gamma, etc.).

The MHP AD unit 670 may determine, as part of the MHP AD, information that may be used to determine one or more parameters for use in MHP. For example, the MHP AD may include information related to simulated propagation rays/paths while assuming infinite bandwidth for signal measurement. This information may include timing information (e.g., ToA), power information (e.g., RSSI (Received Signal Strength Indication)), and/or phase information. As another example, the MHP AD may include information (e.g., timing, power, and/or phase information) related to simulated propagation rays/paths while assuming limited bandwidth (e.g., 100 MHz) for signal measurement. As another example, the MHP AD may include a time difference and/or distribution of time difference between simulated propagation rays/paths. As another example, the MHP AD may include a delay spread (e.g., time difference between first arrival time and last arrival time) or a distribution of delay spread of simulated propagation rays/paths. As another example, the MHP AD may include path/peak/tap width of an earliest arrival of the simulated propagation rays/paths. For example, the path/peak/tap width may be the 3 dB width, e.g., the tap width 910, of a probability distribution function. If the tap width is too wide, e.g., above a threshold, then there may be two paths that are not resolvable, which may act as a trigger to use multiple hypotheses for the time of arrival related to this tap (peak).

The MHP AD unit 670 may determine, as part of the MHP AD, one or more conditions possibly influencing whether to use MHP. For example, the MHP AD may include a condition related to a radio condition. For example, a radio condition may be whether a reference signal (RS) or carrier power (e.g., SINR (Signal-to-Interference-plus-Noise Ratio)/RSRP) satisfies a power threshold (e.g., SINR smaller than X). For example, the frequency domain may be used to compute an RSRP value representing an entire RS (i.e., from multiple reception paths). As another example, the power considered may be the peak power of the earliest arrival of the RS. As another example, the power of multiple arrivals may be considered to select a single power or a combination of powers (e.g., a highest peak selected, or an average of multiple peaks used). As another example of a radio condition, the radio condition may be whether an RS delay spread satisfies a delay spread threshold. As another example, the radio condition may be whether an RS first arrival path/peak/tap satisfies a threshold. As another example, the radio condition may be whether an RS Rician factor (K-factor) (which may be calculated as a ratio of signal power of a direct path divided by power of scattered paths, or as a ratio of signal power in a dominant component over scattered, reflected power) satisfies a Rician threshold. The condition related to a radio condition may provide a MHP use recommendation and may provide one or more MHP parameter recommendations. For example, MHP may be recommended if the RS or carrier power exceeds the power threshold, or if the RS delay spread exceeds the delay spread threshold, or if the RS first arrival tap width exceeds a tap-width threshold, or if a Rician factor is larger than a Rician threshold, or a combination thereof. As an example of an MHP recommendation in view of a condition, MHP may be recommended to be used with up to or at least K hypotheses and a Gaussian probability distribution based on an RS or carrier radio condition (e.g., SINR/RSRP) satisfying a respective threshold. If a combination of conditions are used, then one or more of the thresholds may be different than a threshold used for evaluating the respective condition alone (e.g., a tap width threshold may be Xms if the only condition considered is tap width, but may be Zms (where Z may be greater than or less than X) if tap width is considered in combination with another condition).

At stage 1120, one or more MHP positioning models may be determined. For example, the DTF 600, e.g., the AIML unit 660, may determine one or more positioning models for MHP based on the DT and MHP AD determined at stage 1110. The MHP AD may be used to train one or more AIML positioning models. For example, the MHP AD may be used to decide on synthetic data to be considered for training one or more multi-hypotheses AIML positioning models (e.g., to produce synthetic data using recommended/preferred multi-hypotheses settings). The MHP AD may be used to decide on OTA (Over-The-Air) data collection to be considered for training the model(s) (e.g., to produce synthetic data using recommended/preferred multi-hypotheses settings). If OTA data are to be collected, the collection may be concentrated on areas identified in the MHP AD as being difficult, e.g., where MHP is recommended. The MHP AD may also or alternatively be used to run one or more AIML positioning models. For example, the MHP AD may be used to decide on model selection (including switching between models if multiple models are available and switching is determined to be desired (e.g., because improved positioning accuracy is expected by switching models)). As another example, the MHP AD may be used as model input indexing while running a multi-hypotheses AIML positioning model.

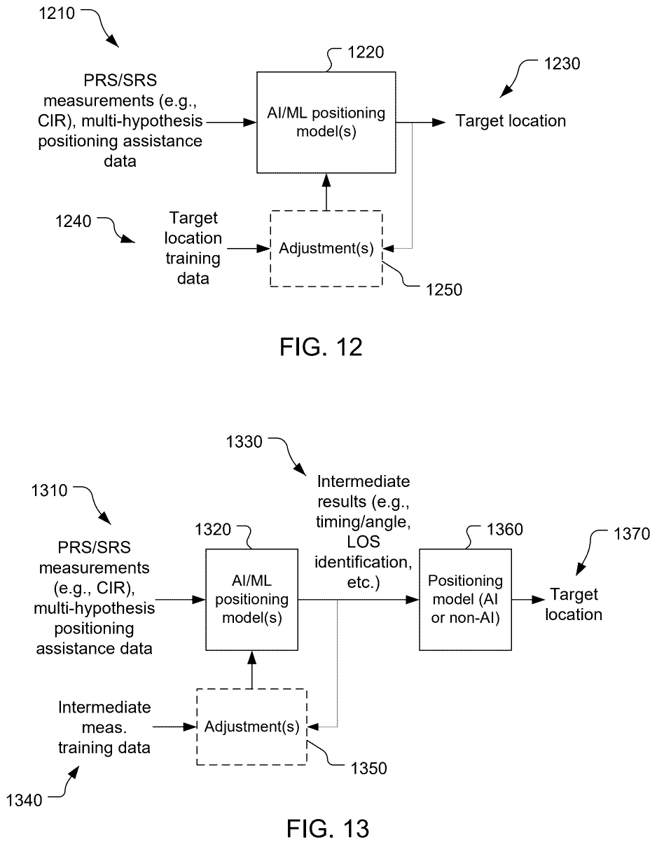

Referring also to FIG. 12, the AIML unit 660 may obtain positioning signal (e.g., PRS, SRS) measurements and the MHP AD obtained at stage 1110 to produce inputs 1210 to one or more AIML positioning models 1220 to produce a candidate location estimate 1230 of a target mobile device (whose location is to be determined). The AIML unit 660 may use target location training data 1240 (e.g., a known location of the target mobile device corresponding to the inputs 1210) to determine one or more model adjustments 1250 and use the adjustment(s) 1250 to alter the AIML positioning model(s) 1220.

Referring also to FIG. 13, the AIML unit 660 may obtain positioning signal (e.g., PRS, SRS) and the MHP AD obtained at stage 1110 to produce inputs 1310 to one or more AIML positioning models 1320 to produce intermediate results 1330 (e.g., timing/angle measurement(s), LOS/NLOS indication, etc.). The AIML unit 660 may use intermediate result training data 1340 (e.g., known angle/timing, LOS/NLOS status, etc. corresponding to the inputs 1310) to determine one or more model adjustments 1350 and use the adjustment(s) 1350 to alter the AIML positioning model(s) 1320. The intermediate results 1330 may be used by the AIML unit 660 in a positioning model 1360 to determine a location estimate 1370 of a target mobile device (whose location is to be determined).

Referring again in particular to FIG. 11, at stage 1130 with further reference to FIGS. 5 and 6, the MHP AD may be provided to the MHPE 500. The MHP AD may be provided in response to a request for MHP AD from the MHPE 500 or by the DTF 600 without a request from the MHPE 500. For example, the MHPE 500 may transmit an MHP AD request 1132 via the transceiver 520 to the DTF 600, which the DTF 600 may receive via the transceiver 620. The request 1132 may comprise a unique (e.g., new) request signaling, or may be a new portion of an existing message type. The request 1132 may include information indicating a scenario for the MHPE 500, e.g., an area in which the target mobile device is disposed, a mobile device status/situation, a 2D/3D model of the scenario, etc. The request 1132 may include one or more specific parameters for digital twin evaluation (and possibly optimization), e.g., a range of hypotheses and potential probability distributions, available bandwidth, TRP listing (e.g., of TRP within communication range of the target mobile device), RS listing (e.g., of available and/or measurable RS), ray tracing parameters, etc. The ray tracing parameters may include the method of ray tracing (e.g., shoot-and-bounce (SBR) method, image method, hybrid method (SBR and image). Also or alternatively, the ray tracing parameters may include ray tracing resolution (e.g., angle separation, number or rays, number of image reflections, etc.), one or more radio propagation parameters (e.g., number of reflections, number of transmissions through walls, number of diffractions, etc.), methodology for computing diffraction (e.g., UAT, GTD, UTD, physical optics, spectral methods, multi-edge diffraction methods (e.g., Deygout model, Epstein-Peterson model, etc.), etc.), methodology for computing scattering (e.g., Lambertian scattering, directive scattering, directive backscattering, multiple scattering theory, etc.), and/or ray tracing boundary (e.g., area/region to which to apply ray tracing), etc. The request 1132 may be sent directly from the MHPE 500 (e.g., a mobile device) to the DTF 600 as shown, or from a mobile device to the LMF 1105, or from a mobile device to the DTF 600 via the LMF 1105 (if the LMF 1105 and the DTF 600 are separate entities). While stage 1110 is shown before stage 1130, the DTF 600 may determined the MHP AD in response to receiving the MHP AD request message 1132, may determine all the requested MHP AD if possible, and/or may determine only the requested MHP AD.

Also at stage 1130, the DTF 600 may transmit an MHP AD message 1134 (containing the MHP AD) via the transceiver 620 and the MHPE 500 may receive the message 1134 via the transceiver 520. The message 1134 may be transmitted in response to receiving the request 1132. The message 1134 may include requested MHP AD and/or other MHP AD. The MHP AD message 1134 may comprise unique (e.g., new) signaling or may be a new part of an existing message. The MHP AD message 1134 may include, e.g., feasibility, condition(s), MHP parameter(s), etc. The MHP AD message 1134 may be transmitted from the DTF 600 directly to the MHPE 500 (e.g., a mobile device), or from the DTF 600 to the LMF 1105 (if the LMF 1105 is separate from the DTF 600) and then to the MHPE 500, or from the LMF 1105 to the MHPE 500 (e.g., if the LMF 1105 and the DTF 600 are not separate entities).

Also at stage 1130, the LMF 1105 may configure the MHPE for positioning and measurement reporting according to the MHP AD as recommended/preferred by the DTF 600. For example, the DTF 600 may transmit the MHP AD message 1134 to the LMF 1105 and the LMF 1105 may use the MHP AD message 1134 to determine configuration information, e.g., the positioning model(s) for the MHPE 500 to use, what positioning information to report and/or how to report position information (e.g., including how often to report position information (e.g., position estimate, position uncertainty). The LMF 1105 may transmit the configuration information to the MHPE 500 in an MHPE configuration message 1136. This may be the case particularly where the MHP AD request is sent from the MHPE 500 to the LMF 1105 to the DTF 600 and the MHP AD is provided by the DTF 600 to the LMF 1105 to the MHPE 500.

At stage 1140, the MHPE 500 may obtain one or more positioning models. For example, the MHPE 500, e.g., the positioning unit 550, may receive one or more positioning models via the transceiver 520, e.g., as part of the MHP AD in the MHP AD message 1134. As another example, the MHPE 500, e.g., the positioning unit 550, may determine one or more positioning models, e.g., based on the MHP AD in the MHP AD message 1134, as discussed above with respect to FIG. 12 and/or FIG. 13. The positioning unit 550 may consider all of the MHP AD as recommended by the DTF 600, or may consider some, but not all, of the MHP AD provided by the DTF 600 (e.g., if the MHPE 500 lacks resources (e.g., battery power and/or memory) to consider all of the MHP AD).

At stage 1150, the MHPE 500, e.g., the positioning unit 550, may determine whether to run MHP. The MHPE 500 may determine to run MHP based on receiving an instruction to run MHP from the DTF 600, e.g., in the MHPE configuration message 1136 or in the MHP AD message 1134 from the DTF 600. The MHPE 500 may consider multi-hypothesis positioning autonomously and indicate to the LMF 1105 whether the MHPE 500 determines to use MHP. For example, the MHPE 500 may determine to run MHP based on digital twin information independent of the MHP AD.

At stage 1160, the MHPE 500 may run MHP and report running of MHP. The MHPE 500 may transmit a position report 1162 to the LMF 1105 reporting use (or non-use) of MHP and position information, e.g., a position estimate for the target mobile device. The MHPE 500 may report use (or non-use) of MHP regardless of how the MHPE 500 determines whether to use MHP. This information may be used, e.g., by the AIML unit 660 of the DTF 600, to determine whether MHP AD was helpful (e.g., improved positioning accuracy), and to train one or more AIML models.

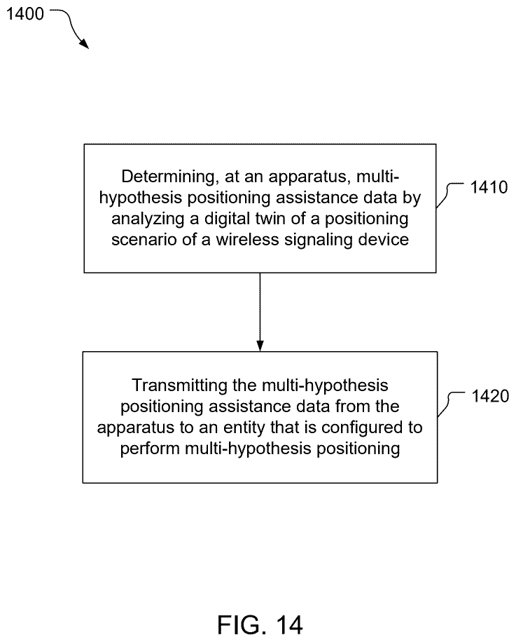

Referring to FIG. 14, with further reference to FIGS. 1-13, a multi-hypothesis positioning assistance data method 1400 includes the stages shown. The method 1400 is, however, an example only and not limiting. The method 1400 may be altered, e.g., by having one or more stages added, removed, rearranged, combined, performed concurrently, and/or by having one or more single stages split into multiple stages.

At stage 1410, the method 1400 includes determining, at an apparatus, multi-hypothesis positioning assistance data by analyzing a digital twin of a positioning scenario of a wireless signaling device. For example, at stage 1110 the DTF 600, e.g., the MHP AD unit 670 in combination with the DTF unit 650, may (produce and) analyze a digital twin, e.g., of a communication channel, to determine MHP AD including feasibility of using MHP, one or more parameters for implementing MHP (including a quantity of hypotheses and/or one or more probability distributions (e.g., for arrivals of signals)), and/or a condition corresponding to MHP (e.g., affecting whether to implement MHP). As another example, at stage 1120 the DTF unit 650 may determine one or more positioning models for use in implementing MHP. The processor 610, possibly in combination with the memory 630, may comprise means for analyzing a digital twin.

At stage 1420, the method 1400 includes transmitting the multi-hypothesis positioning assistance data from the apparatus to an entity that is configured to perform multi-hypothesis positioning. In the multi-hypothesis positioning, multiple hypotheses (e.g., of arrival times of the positioning signal, positioning signal transmit times, signal timing measurements (e.g., RTT), power levels, phases, AoA, AoD, and/or LOS/NLOS etc.) are evaluated to determine an estimated position of a target wireless signaling device. For example, at stage 1130 the DTF 600 may transmit the MHP AD to the MHPE 500 in the MHP AD message 1134. The processor 610, possibly in combination with the memory 630, in combination with the transceiver 620 (e.g., the wired transmitter 452 and/or the wireless transmitter 442 and the antenna 446) may comprise means for transmitting the MHP AD.

Implementations of the method 1400 may include one or more of the following features. In an example implementation, the multi-hypothesis positioning assistance data comprise at least one of (1) an indication of feasibility of multi-hypothesis positioning for the positioning scenario, (2) an indication corresponding to at least one multi-hypothesis positioning parameter where the at least one multi-hypothesis positioning parameter comprises at least one of (a) a quantity of hypotheses, and (b) at least one probability distribution function of arrival time of a positioning signal at the mobile device, and (3) an indication of at least one condition corresponding to a multi-hypothesis positioning recommendation. In a further example implementation, the indication of feasibility of multi-hypothesis positioning for the positioning scenario, where the indication of feasibility of multi-hypothesis positioning for the positioning scenario indicates one of: that multi-hypothesis positioning is feasible and recommended; that multi-hypothesis positioning is feasible and has comparable performance to single-hypothesis positioning, and; that multi-hypothesis positioning is at least one of not feasible and not recommended. In another further example implementation, the multi-hypothesis positioning assistance data comprise the indication corresponding to the at least one multi-hypothesis positioning parameter, and comprises at least one of: information, related to simulated propagation rays, including at least one of timing information, power information, and phase information; an indication of time difference between the simulated propagation rays; an indication of delay spread between the simulated propagation rays; and an indication of tap width of an earliest arrival of the simulated propagation rays. The time difference between simulated propagation rays may be, for example, the time between peaks of simulated signal receptions, or the time between other reference points (e.g., 3 dB points of probability distributions).

Also or alternatively, implementations of the method 1400 may include one or more of the following features. In an example implementation, the multi-hypothesis positioning assistance data comprise the indication of at least one condition corresponding to the multi-hypothesis positioning recommendation, the at least one condition comprising at least one of: received signal power relative to a power threshold; delay spread relative to a delay spread threshold; received signal tap width relative to a tap-width threshold; and received signal Rician factor related to a Rician threshold. In a further example implementation, the at least one condition comprises a combination of at least two of the conditions, where at least one value of at least one of the respective thresholds depends on the combination of the at least two of the conditions. In another further example implementation, the multi-hypothesis positioning assistance data further comprise the indication corresponding to the at least one multi-hypothesis positioning parameter.

Also or alternatively, implementations of the method 1400 may include one or more of the following features. In an example implementation, the method 1400 further includes receiving, at the apparatus, a request for the multi-hypothesis positioning assistance data, the request indicating at least one of: at least one acceptable multi-hypothesis positioning parameter value; geographic model information of a region in which the wireless signaling device is disposed; ray tracing information; and wireless signaling device scenario status within the positioning scenario. For example, at stage 1130 the DTF 600 may receive the MHP AD request message 1132. The processor 610, possibly in combination with the memory 630, in combination with the transceiver 620 (e.g., the wired receiver 454 and/or the wireless receiver 444 and the antenna 446) may comprise means for receiving the request for MHP AD. In another example implementation, the method 1400 further includes training an artificial intelligence model using at least some of the multi-hypothesis positioning assistance data. For example, at stage 1120 the DTF 600 (e.g., the AIML unit 660) may train one or more positioning models, e.g., as discussed with respect to FIG. 12 and/or FIG. 13. The processor 610, possibly in combination with the memory 630, may comprise means for training an artificial intelligence model.

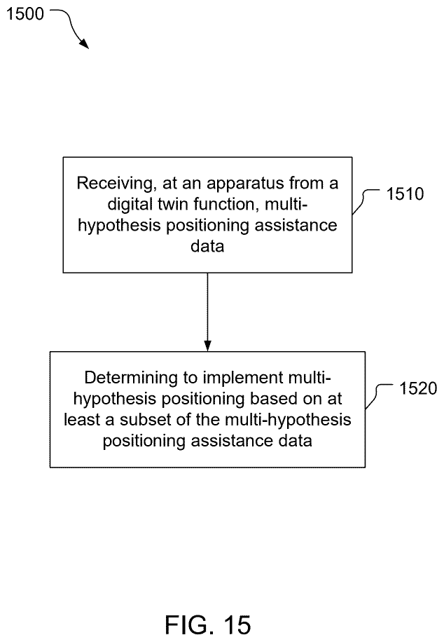

Referring to FIG. 15, with further reference to FIGS. 1-13, a multi-hypothesis positioning method 1500 includes the stages shown. The method 1500 is, however, an example only and not limiting. The method 1500 may be altered, e.g., by having one or more stages added, removed, rearranged, combined, performed concurrently, and/or by having one or more single stages split into multiple stages.

At stage 1510, the method 1500 includes receiving, at an apparatus from a digital twin function, multi-hypothesis positioning assistance data. For example, at stage 1130 the MHPE 500 may receive MHP AD in the MHP AD message 1134. The positioning scenario of the (target) mobile device may include one or more scenarios including a present scenario of the mobile device. The received MHP AD may be in response to the MHP AD request message 1132 that may specify one or more scenarios such that the received MHP AD may correspond to the indicated scenario(s), which may include a present scenario. The processor 510, possibly in combination with the memory 530, in combination with the transceiver 520 (e.g., the wired receiver 254 and/or the wireless receiver 244 and the antenna 246) may comprise means for receiving MHP AD.

At stage 1520, the method 1500 includes determining to implement multi-hypothesis positioning based on at least a subset of the multi-hypothesis positioning assistance data. The multi-hypothesis positioning may comprise determination and evaluation of multiple hypotheses (e.g., of arrival times of the positioning signal, positioning signal transmit times, signal timing measurements (e.g., RTT), power levels, phases, AoA, AoD, and/or LOS/NLOS etc.) to determine an estimated position of a target wireless signaling device. For example, at stage 1150 the MHPE 500, e.g., the positioning unit 550, may determine whether to implement MHP and may conclude to implement MHP. The processor 510, possibly in combination with the memory 530, may comprise means for determining to implement MHP.

Implementations of the method 1500 may include one or more of the following features. In an example implementation, the multi-hypothesis positioning assistance data comprise at least one of (1) an indication of feasibility of multi-hypothesis positioning for a positioning scenario of a mobile device, (2) an indication corresponding to at least one multi-hypothesis positioning parameter where the at least one multi-hypothesis positioning parameter comprises at least one of (a) a quantity of hypotheses, and (b) at least one probability distribution function of arrival time of a positioning signal at the mobile device, and (3) an indication of at least one condition corresponding to a multi-hypothesis positioning recommendation. In another example implementation, the method 1500 includes determining what data of the multi-hypothesis positioning assistance data to consider to determine to implement the multi-hypothesis positioning. For example, assistance data (AD) may be determined by considering one or more factors such as expected positioning accuracy, expected measurement (e.g., timing, LOS, etc.) accuracy, dilution of precision, properties of PDP (Power Delay Profile) (e.g., delay spread, peak width, Rician factor, etc.). For example, depending on the expected accuracy, the AD may be determined to help ensure that recommended MHP AD can achieve the expected accuracy. As another example, if a peak width or another radio metric of channel response exceeds a threshold, then this can be used as a factor to determine the MHP AD. For example, if the peak width exceeds a threshold, N number of hypotheses are recommended. The processor 510, possibly in combination with the memory 530, may comprise means for determining what data of the multi-hypothesis positioning assistance data to consider to determine to implement the multi-hypothesis positioning. In a further example implementation, what data of the multi-hypothesis positioning assistance data to consider is based on whether the multi-hypothesis positioning assistance data are received from a location management function.

Also or alternatively, implementations of the method 1500 may include one or more of the following features. In an example implementation, the multi-hypothesis positioning assistance data comprise a recommendation to implement multi-hypothesis positioning, and wherein determining to implement multi-hypothesis positioning comprises following the recommendation to implement multi-hypothesis positioning. In another example implementation, the multi-hypothesis positioning assistance data comprise at least one recommended multi-hypothesis positioning parameter, and wherein determining to implement multi-hypothesis positioning comprises determining whether to implement multi-hypothesis positioning using the at least one recommended multi-hypothesis positioning parameter. In another example implementation, the method 1500 includes operating an artificial intelligence model based on at least some of the multi-hypothesis positioning assistance data. For example, at stage 1160 the MHPE 500, e.g., the positioning unit 550, may operation an AIML model, e.g., the AIML model 1220 or the AIML model 1320 in order to determine a location estimate of a target mobile device using MHP. The processor 510, possibly in combination with the memory 530, may comprise means for operating an artificial intelligence model. In a further example implementation, operating the artificial intelligence model based on at least some of the multi-hypothesis positioning assistance data comprises at least one of selecting the artificial intelligence model based on at least some of the multi-hypothesis positioning assistance data, and using at least some of the multi-hypothesis positioning assistance data as input to the artificial intelligence model.

### Implementation Examples

Implementation examples are provided in the following numbered clauses.

Clause 1. A multi-hypothesis positioning method comprising:
receiving, at an apparatus from a digital twin function, multi-hypothesis positioning assistance data; and
determining to implement multi-hypothesis positioning based on at least a subset of the multi-hypothesis positioning assistance data.

Clause 2. The method of clause 1, wherein the multi-hypothesis positioning assistance data comprise at least one of (1) an indication of feasibility of multi-hypothesis positioning for a positioning scenario of a wireless signaling device, (2) an indication corresponding to at least one multi-hypothesis positioning parameter where the at least one multi-hypothesis positioning parameter comprises at least one of (a) a quantity of hypotheses, and (b) at least one probability distribution function of arrival time of a positioning signal at the wireless signaling device, and (3) an indication of at least one condition corresponding to a multi-hypothesis positioning recommendation.

Clause 3. The method of clause 1, further comprising determining what data of the multi-hypothesis positioning assistance data to consider to determine to implement the multi-hypothesis positioning.

Clause 4. The method of clause 3, wherein determining what data of the multi-hypothesis positioning assistance data to consider is based on whether the multi-hypothesis positioning assistance data are received from a location management function.

Clause 5. The method of clause 1, wherein the multi-hypothesis positioning assistance data comprise a recommendation to implement multi-hypothesis positioning, and wherein determining to implement multi-hypothesis positioning comprises following the recommendation to implement multi-hypothesis positioning.

Clause 6. The method of clause 1, wherein the multi-hypothesis positioning assistance data comprise at least one recommended multi-hypothesis positioning parameter, and wherein determining to implement multi-hypothesis positioning comprises determining whether to implement multi-hypothesis positioning using the at least one recommended multi-hypothesis positioning parameter.

Clause 7. The method of clause 1, further comprising operating an artificial intelligence model based on at least some of the multi-hypothesis positioning assistance data.

Clause 8. The method of clause 7, wherein operating the artificial intelligence model based on at least some of the multi-hypothesis positioning assistance data comprises at least one of selecting the artificial intelligence model based on at least some of the multi-hypothesis positioning assistance data, and using at least some of the multi-hypothesis positioning assistance data as input to the artificial intelligence model.

Clause 9. An apparatus, for implementing multi-hypothesis positioning, comprising:
at least one transceiver;
at least one memory;
at least one processor, communicatively coupled to the at least one transceiver and the at least one memory, configured to:
   receive, via the at least one transceiver from a digital twin function, multi-hypothesis positioning assistance data; and
   determine to implement multi-hypothesis positioning based on at least a subset of the multi-hypothesis positioning assistance data.

Clause 10. The apparatus of clause 9, wherein the multi-hypothesis positioning assistance data comprise at least one of (1) an indication of feasibility of multi-hypothesis positioning for a positioning scenario of a wireless signaling device, (2) an indication corresponding to at least one multi-hypothesis positioning parameter where the at least one multi-hypothesis positioning parameter comprises at least one of (a) a quantity of hypotheses, and (b) at least one probability distribution function of arrival time of a positioning signal at the wireless signaling device, and (3) an indication of at least one condition corresponding to a multi-hypothesis positioning recommendation.

Clause 11. The apparatus of clause 9, wherein the at least one processor is configured to determine what data of the multi-hypothesis positioning assistance data to consider to determine to implement the multi-hypothesis positioning.

Clause 12. The apparatus of clause 11, wherein to determine what data of the multi-hypothesis positioning assistance data to consider the at least one processor is configured to determine whether the multi-hypothesis positioning assistance data are received from a location management function.

Clause 13. The apparatus of clause 9, wherein the multi-hypothesis positioning assistance data comprise a recommendation to implement multi-hypothesis positioning, and wherein to determine to implement multi-hypothesis positioning the at least one processor is configured to determine to follow the recommendation to implement multi-hypothesis positioning.

Clause 14. The apparatus of clause 9, wherein the multi-hypothesis positioning assistance data comprise at least one recommended multi-hypothesis positioning parameter, and wherein to determine to implement multi-hypothesis positioning the at least one processor is configured to determine to implement multi-hypothesis positioning using the at least one recommended multi-hypothesis positioning parameter.

Clause 15. The apparatus of clause 9, wherein the at least one processor is configured to operate an artificial intelligence model based on at least some of the multi-hypothesis positioning assistance data.

Clause 16. The apparatus of clause 15, wherein to operate the artificial intelligence model based on at least some of the multi-hypothesis positioning assistance data the at least one processor is configured to at least one of select the artificial intelligence model based on at least some of the multi-hypothesis positioning assistance data, and use at least some of the multi-hypothesis positioning assistance data as input to the artificial intelligence model.

Clause 17. An apparatus, for implementing multi-hypothesis positioning, comprising:
means for receiving, from a digital twin function, multi-hypothesis positioning assistance data; and
means for determining to implement multi-hypothesis positioning based on at least a subset of the multi-hypothesis positioning assistance data.

Clause 18. The apparatus of clause 17, wherein the multi-hypothesis positioning assistance data comprise at least one of (1) an indication of feasibility of multi-hypothesis positioning for a positioning scenario of a wireless signaling device, (2) an indication corresponding to at least one multi-hypothesis positioning parameter where the at least one multi-hypothesis positioning parameter comprises at least one of (a) a quantity of hypotheses, and (b) at least one probability distribution function of arrival time of a positioning signal at the wireless signaling device, and (3) an indication of at least one condition corresponding to a multi-hypothesis positioning recommendation.

Clause 19. The apparatus of clause 17, further comprising means for determining what data of the multi-hypothesis positioning assistance data to consider to determine to implement the multi-hypothesis positioning.

Clause 20. The apparatus of clause 19, wherein the means for determining what data of the multi-hypothesis positioning assistance data to consider comprise means for determining whether the multi-hypothesis positioning assistance data are received from a location management function.

Clause 21. The apparatus of clause 17, wherein the multi-hypothesis positioning assistance data comprise a recommendation to implement multi-hypothesis positioning, and wherein the means for determining to implement multi-hypothesis positioning comprise means for following the recommendation to implement multi-hypothesis positioning.

Clause 22. The apparatus of clause 17, wherein the multi-hypothesis positioning assistance data comprise at least one recommended multi-hypothesis positioning parameter, and wherein the means for determining to implement multi-hypothesis positioning comprise means for determining whether to implement multi-hypothesis positioning using the at least one recommended multi-hypothesis positioning parameter.

Clause 23. The apparatus of clause 17, further comprising means for operating an artificial intelligence model based on at least some of the multi-hypothesis positioning assistance data.

Clause 24. The apparatus of clause 23, wherein the means for operating the artificial intelligence model based on at least some of the multi-hypothesis positioning assistance data comprise at least one of means for selecting the artificial intelligence model based on at least some of the multi-hypothesis positioning assistance data, and means for using at least some of the multi-hypothesis positioning assistance data as input to the artificial intelligence model.

Clause 25. A non-transitory, processor-readable storage medium comprising processor-readable instructions to cause at least one processor of an apparatus to:
receive, from a digital twin function, multi-hypothesis positioning assistance data; and
determine to implement multi-hypothesis positioning based on at least a subset of the multi-hypothesis positioning assistance data.

Clause 26. The non-transitory, processor-readable storage medium of clause 25, wherein the multi-hypothesis positioning assistance data comprise at least one of (1) an indication of feasibility of multi-hypothesis positioning for a positioning scenario of a wireless signaling device, (2) an indication corresponding to at least one multi-hypothesis positioning parameter where the at least one multi-hypothesis positioning parameter comprises at least one of (a) a quantity of hypotheses, and (b) at least one probability distribution function of arrival time of a positioning signal at the wireless signaling device, and (3) an indication of at least one condition corresponding to a multi-hypothesis positioning recommendation.

Clause 27. The non-transitory, processor-readable storage medium of clause 25, further comprising processor-readable instructions to cause the at least one processor to determine what data of the multi-hypothesis positioning assistance data to consider to determine to implement the multi-hypothesis positioning.

Clause 28. The non-transitory, processor-readable storage medium of clause 27, wherein the processor-readable instructions to cause the at least one processor to determine what data of the multi-hypothesis positioning assistance data to consider comprise processor-readable instructions to cause the at least one processor to determine whether the multi-hypothesis positioning assistance data are received from a location management function.

Clause 29. The non-transitory, processor-readable storage medium of clause 25, wherein the multi-hypothesis positioning assistance data comprise a recommendation to implement multi-hypothesis positioning, and wherein the processor-readable instructions to cause the at least one processor to determine to implement multi-hypothesis positioning comprise processor-readable instructions to cause the at least one processor to follow the recommendation to implement multi-hypothesis positioning.

Clause 30. The non-transitory, processor-readable storage medium of clause 25, wherein the multi-hypothesis positioning assistance data comprise at least one recommended multi-hypothesis positioning parameter, and wherein the processor-readable instructions to cause the at least one processor to determine to implement multi-hypothesis positioning comprise processor-readable instructions to cause the at least one processor to determine whether to implement multi-hypothesis positioning using the at least one recommended multi-hypothesis positioning parameter.

Clause 31. The non-transitory, processor-readable storage medium of clause 25, further comprising processor-readable instructions to cause the at least one processor to operate an artificial intelligence model based on at least some of the multi-hypothesis positioning assistance data.

Clause 32. The non-transitory, processor-readable storage medium of clause 31, wherein the processor-readable instructions to cause the at least one processor to operate the artificial intelligence model based on at least some of the multi-hypothesis positioning assistance data comprise at least one of processor-readable instructions to cause the at least one processor to select the artificial intelligence model based on at least some of the multi-hypothesis positioning assistance data, and processor-readable instructions to cause the at least one processor to use at least some of the multi-hypothesis positioning assistance data as input to the artificial intelligence model.

Clause 33. A multi-hypothesis positioning assistance data method comprising:
determining, at an apparatus, multi-hypothesis positioning assistance data by analyzing a digital twin of a positioning scenario of a wireless signaling device; and
transmitting the multi-hypothesis positioning assistance data from the apparatus to an entity that is configured to perform multi-hypothesis positioning.

Clause 34. The method of clause 33, wherein the multi-hypothesis positioning assistance data comprise at least one of (1) an indication of feasibility of multi-hypothesis positioning for the positioning scenario, (2) an indication corresponding to at least one multi-hypothesis positioning parameter where the at least one multi-hypothesis positioning parameter comprises at least one of (a) a quantity of hypotheses, and (b) at least one probability distribution function of arrival time of a positioning signal at the wireless signaling device, and (3) an indication of at least one condition corresponding to a multi-hypothesis positioning recommendation.

Clause 35. The method of clause 34, wherein the multi-hypothesis positioning assistance data comprise the indication of feasibility of multi-hypothesis positioning for the positioning scenario, wherein the indication of feasibility of multi-hypothesis positioning for the positioning scenario indicates one of: that multi-hypothesis positioning is feasible and recommended; that multi-hypothesis positioning is feasible and has comparable performance to single-hypothesis positioning, and; that multi-hypothesis positioning is at least one of not feasible and not recommended.

Clause 36. The method of clause 34, wherein the multi-hypothesis positioning assistance data comprise the indication corresponding to the at least one multi-hypothesis positioning parameter, and comprises at least one of:
information, related to simulated propagation rays, including at least one of timing information, power information, and phase information;
an indication of time difference between the simulated propagation rays;
an indication of delay spread between the simulated propagation rays; and
an indication of tap width of an earliest arrival of the simulated propagation rays.

Clause 37. The method of clause 34, wherein the multi-hypothesis positioning assistance data comprise the indication of at least one condition corresponding to the multi-hypothesis positioning recommendation, the at least one condition comprising at least one of:
received signal power relative to a power threshold;
delay spread relative to a delay spread threshold;
received signal tap width relative to a tap-width threshold; and
received signal Rician factor related to a Rician threshold.

Clause 38. The method of clause 37, wherein the at least one condition comprises a combination of at least two of the conditions, and wherein at least one value of at least one of the respective thresholds depends on the combination of the at least two of the conditions.

Clause 39. The method of clause 37, wherein the multi-hypothesis positioning assistance data further comprise the indication corresponding to the at least one multi-hypothesis positioning parameter.

Clause 40. The method of clause 33, further comprising receiving, at the apparatus, a request for the multi-hypothesis positioning assistance data, the request indicating at least one of:
at least one acceptable multi-hypothesis positioning parameter value;
geographic model information of a region in which the wireless signaling device is disposed;
ray tracing information; and
wireless signaling device scenario status within the positioning scenario.

Clause 41. The method of clause 33, further comprising training an artificial intelligence model using at least some of the multi-hypothesis positioning assistance data.

Clause 42. An apparatus, for providing multi-hypothesis positioning assistance data, comprising:
at least one transceiver;
at least one memory;
at least one processor, communicatively coupled to the at least one transceiver and the at least one memory, configured to:
   determine the multi-hypothesis positioning assistance data by analyzing a digital twin of a positioning scenario of a wireless signaling device; and
   transmit, via the at least one transceiver, the multi-hypothesis positioning assistance data to an entity that is configured to perform multi-hypothesis positioning.

Clause 43. The apparatus of clause 42, wherein the multi-hypothesis positioning assistance data comprise at least one of (1) an indication of feasibility of multi-hypothesis positioning for the positioning scenario, (2) an indication corresponding to at least one multi-hypothesis positioning parameter where the at least one multi-hypothesis positioning parameter comprises at least one of (a) a quantity of hypotheses, and (b) at least one probability distribution function of arrival time of a positioning signal at the wireless signaling device, and (3) an indication of at least one condition corresponding to a multi-hypothesis positioning recommendation.

Clause 44. The apparatus of clause 43, wherein the multi-hypothesis positioning assistance data comprise the indication of feasibility of multi-hypothesis positioning for the positioning scenario, wherein the indication of feasibility of multi-hypothesis positioning for the positioning scenario indicates one of: that multi-hypothesis positioning is feasible and recommended; that multi-hypothesis positioning is feasible and has comparable performance to single-hypothesis positioning, and; that multi-hypothesis positioning is at least one of not feasible and not recommended.

Clause 45. The apparatus of clause 43, wherein the multi-hypothesis positioning assistance data comprise the indication corresponding to the at least one multi-hypothesis positioning parameter, and comprises at least one of:
information, related to simulated propagation rays, including at least one of timing information, power information, and phase information;
an indication of time difference between the simulated propagation rays;
an indication of delay spread between the simulated propagation rays; and
an indication of tap width of an earliest arrival of the simulated propagation rays.

Clause 46. The apparatus of clause 43, wherein the multi-hypothesis positioning assistance data comprise the indication of at least one condition corresponding to the multi-hypothesis positioning recommendation, the at least one condition comprising at least one of:
received signal power relative to a power threshold;
delay spread relative to a delay spread threshold;
received signal tap width relative to a tap-width threshold; and
received signal Rician factor related to a Rician threshold.

Clause 47. The apparatus of clause 46, wherein the at least one condition comprises a combination of at least two of the conditions, and wherein at least one value of at least one of the respective thresholds depends on the combination of the at least two of the conditions.

Clause 48. The apparatus of clause 46, wherein the multi-hypothesis positioning assistance data further comprise the indication corresponding to the at least one multi-hypothesis positioning parameter.

Clause 49. The apparatus of clause 42, wherein the at least one processor is configured to receive, via the at least one transceiver, a request for the multi-hypothesis positioning assistance data, the request indicating at least one of:
at least one acceptable multi-hypothesis positioning parameter value;
geographic model information of a region in which the wireless signaling device is disposed;
ray tracing information; and
wireless signaling device scenario status within the positioning scenario.

Clause 50. The apparatus of clause 42, wherein the at least one processor is configured to train an artificial intelligence model using at least some of the multi-hypothesis positioning assistance data.

Clause 51. An apparatus, for providing multi-hypothesis positioning assistance data, comprising:
means for determining multi-hypothesis positioning assistance data by analyzing a digital twin of a positioning scenario of a wireless signaling device; and
means for transmitting the multi-hypothesis positioning assistance data from the apparatus to an entity that is configured to perform multi-hypothesis positioning.

Clause 52. The apparatus of clause 51, wherein the multi-hypothesis positioning assistance data comprise at least one of (1) an indication of feasibility of multi-hypothesis positioning for the positioning scenario, (2) an indication corresponding to at least one multi-hypothesis positioning parameter where the at least one multi-hypothesis positioning parameter comprises at least one of (a) a quantity of hypotheses, and (b) at least one probability distribution function of arrival time of a positioning signal at the wireless signaling device, and (3) an indication of at least one condition corresponding to a multi-hypothesis positioning recommendation.

Clause 53. The apparatus of clause 52, wherein the multi-hypothesis positioning assistance data comprise the indication of feasibility of multi-hypothesis positioning for the positioning scenario, wherein the indication of feasibility of multi-hypothesis positioning for the positioning scenario indicates one of: that multi-hypothesis positioning is feasible and recommended; that multi-hypothesis positioning is feasible and has comparable performance to single-hypothesis positioning, and; that multi-hypothesis positioning is at least one of not feasible and not recommended.

Clause 54. The apparatus of clause 52, wherein the multi-hypothesis positioning assistance data comprise the indication corresponding to the at least one multi-hypothesis positioning parameter, and comprises at least one of:
information, related to simulated propagation rays, including at least one of timing information, power information, and phase information;
an indication of time difference between the simulated propagation rays;
an indication of delay spread between the simulated propagation rays; and
an indication of tap width of an earliest arrival of the simulated propagation rays.

Clause 55. The apparatus of clause 52, wherein the multi-hypothesis positioning assistance data comprise the indication of at least one condition corresponding to the multi-hypothesis positioning recommendation, the at least one condition comprising at least one of:
received signal power relative to a power threshold;
delay spread relative to a delay spread threshold;
received signal tap width relative to a tap-width threshold; and
received signal Rician factor related to a Rician threshold.

Clause 56. The apparatus of clause 55, wherein the at least one condition comprises a combination of at least two of the conditions, and wherein at least one value of at least one of the respective thresholds depends on the combination of the at least two of the conditions.

Clause 57. The apparatus of clause 55, wherein the multi-hypothesis positioning assistance data further comprise the indication corresponding to the at least one multi-hypothesis positioning parameter.

Clause 58. The apparatus of clause 51, further comprising means for receiving a request for the multi-hypothesis positioning assistance data, the request indicating at least one of:
at least one acceptable multi-hypothesis positioning parameter value;
geographic model information of a region in which the wireless signaling device is disposed;
ray tracing information; and
wireless signaling device scenario status within the positioning scenario.

Clause 59. The apparatus of clause 51, further comprising means for training an artificial intelligence model using at least some of the multi-hypothesis positioning assistance data.

Clause 60. A non-transitory, processor-readable storage medium comprising processor-readable instructions to cause at least one processor of an apparatus to:
determine multi-hypothesis positioning assistance data by analyzing a digital twin of a positioning scenario of a wireless signaling device; and
transmit the multi-hypothesis positioning assistance data from the apparatus to an entity that is configured to perform multi-hypothesis positioning.

Clause 61. The non-transitory, processor-readable storage medium of clause 60, wherein the multi-hypothesis positioning assistance data comprise at least one of (1) an indication of feasibility of multi-hypothesis positioning for the positioning scenario, (2) an indication corresponding to at least one multi-hypothesis positioning parameter where the at least one multi-hypothesis positioning parameter comprises at least one of (a) a quantity of hypotheses, and (b) at least one probability distribution function of arrival time of a positioning signal at the wireless signaling device, and (3) an indication of at least one condition corresponding to a multi-hypothesis positioning recommendation.

Clause 62. The non-transitory, processor-readable storage medium of clause 61, wherein the multi-hypothesis positioning assistance data comprise the indication of feasibility of multi-hypothesis positioning for the positioning scenario, wherein the indication of feasibility of multi-hypothesis positioning for the positioning scenario indicates one of: that multi-hypothesis positioning is feasible and recommended; that multi-hypothesis positioning is feasible and has comparable performance to single-hypothesis positioning, and; that multi-hypothesis positioning is at least one of not feasible and not recommended.

Clause 63. The non-transitory, processor-readable storage medium of clause 61, wherein the multi-hypothesis positioning assistance data comprise the indication corresponding to the at least one multi-hypothesis positioning parameter, and comprises at least one of:
information, related to simulated propagation rays, including at least one of timing information, power information, and phase information;
an indication of time difference between the simulated propagation rays;
an indication of delay spread between the simulated propagation rays; and
an indication of tap width of an earliest arrival of the simulated propagation rays.

Clause 64. The non-transitory, processor-readable storage medium of clause 61, wherein the multi-hypothesis positioning assistance data comprise the indication of at least one condition corresponding to the multi-hypothesis positioning recommendation, the at least one condition comprising at least one of:
received signal power relative to a power threshold;
delay spread relative to a delay spread threshold;
received signal tap width relative to a tap-width threshold; and
received signal Rician factor related to a Rician threshold.

Clause 65. The non-transitory, processor-readable storage medium of clause 64, wherein the at least one condition comprises a combination of at least two of the conditions, and wherein at least one value of at least one of the respective thresholds depends on the combination of the at least two of the conditions.

Clause 66. The non-transitory, processor-readable storage medium of clause 64, wherein the multi-hypothesis positioning assistance data further comprise the indication corresponding to the at least one multi-hypothesis positioning parameter.

Clause 67. The non-transitory, processor-readable storage medium of clause 60, further comprising processor-readable instructions to cause the at least one processor to receive a request for the multi-hypothesis positioning assistance data, the request indicating at least one of:
at least one acceptable multi-hypothesis positioning parameter value;
geographic model information of a region in which the wireless signaling device is disposed;
ray tracing information; and
wireless signaling device scenario status within the positioning scenario.

Clause 68. The non-transitory, processor-readable storage medium of clause 60, further comprising processor-readable instructions to cause the at least one processor to train an artificial intelligence model using at least some of the multi-hypothesis positioning assistance data.

### Other Considerations

Other examples and implementations are within the scope of the disclosure and appended claims. For example, due to the nature of software and computers, functions described above can be implemented using software executed by a processor, hardware, firmware, hardwiring, or a combination of any of these. Features implementing functions may also be physically located at various positions, including being distributed such that portions of functions are implemented at different physical locations.

As used herein, the singular forms “a,” “an,” and “the” include the plural forms as well, unless the context clearly indicates otherwise. Thus, reference to a device in the singular (e.g., “a device,” “the device”), including in the claims, includes at least one, i.e., one or more, of such devices (e.g., “a processor” includes at least one processor (e.g., one processor, two processors, etc.), “the processor” includes at least one processor, “a memory” includes at least one memory, “the memory” includes at least one memory, etc.). The phrases “at least one” and “one or more” are used interchangeably and such that “at least one” referred-to object and “one or more” referred-to objects include implementations that have one referred-to object and implementations that have multiple referred-to objects. For example, “at least one processor” and “one or more processors” each includes implementations that have one processor and implementations that have multiple processors. Also, a “set” as used herein includes one or more members, and a “subset” contains fewer than all members of the set to which the subset refers.

The terms “comprises,” “comprising,” “includes,” and/or “including,” as used herein, specify the presence of stated features, integers, steps, operations, elements, and/or components, but do not preclude the presence or addition of one or more other features, integers, steps, operations, elements, components, and/or groups thereof.

Also, as used herein, a list of items prefaced by “at least one of” or prefaced by “one or more of” indicates a disjunctive list such that, for example, a list of “at least one of A, B, or C,” or a list of “at least one of A, B, and C,” or a list of “one or more of A, B, or C”, or a list of “one or more of A, B, and C,” or a list of “A or B or C” means A, or B, or C, or AB (A and B), or AC (A and C), or BC (B and C), or ABC (i.e., A and B and C), or combinations with more than one feature (e.g., AA, AAB, ABBC, etc.). Thus, a recitation that an item, e.g., a processor, is configured to perform a function regarding at least one of A or B, or a recitation that an item is configured to perform a function A or a function B, means that the item may be configured to perform the function regarding A, or may be configured to perform the function regarding B, or may be configured to perform the function regarding A and B. For example, a phrase of “a processor configured to measure at least one of A or B” or “a processor configured to measure A or measure B” means that the processor may be configured to measure A (and may or may not be configured to measure B), or may be configured to measure B (and may or may not be configured to measure A), or may be configured to measure A and measure B (and may be configured to select which, or both, of A and B to measure). Similarly, a recitation of a means for measuring at least one of A or B includes means for measuring A (which may or may not be able to measure B), or means for measuring B (and may or may not be configured to measure A), or means for measuring A and B (which may be able to select which, or both, of A and B to measure). As another example, a recitation that an item, e.g., a processor, is configured to at least one of perform function X or perform function Y means that the item may be configured to perform the function X, or may be configured to perform the function Y, or may be configured to perform the function X and to perform the function Y. For example, a phrase of “a processor configured to at least one of measure X or measure Y” means that the processor may be configured to measure X (and may or may not be configured to measure Y), or may be configured to measure Y (and may or may not be configured to measure X), or may be configured to measure X and to measure Y (and may be configured to select which, or both, of X and Y to measure).

As used herein, unless otherwise stated, a statement that a function or operation is “based on” an item or condition means that the function or operation is based on the stated item or condition and may be based on one or more items and/or conditions in addition to the stated item or condition.

Substantial variations may be made in accordance with specific requirements. For example, customized hardware might also be used, and/or particular elements might be implemented in hardware, software (including portable software, such as applets, etc.) executed by a processor, or both. Further, connection to other computing devices such as network input/output devices may be employed. Components, functional or otherwise, shown in the figures and/or discussed herein as being connected or communicating with each other are communicatively coupled unless otherwise noted. That is, they may be directly or indirectly connected to enable communication between them.

The systems and devices discussed above are examples. Various configurations may omit, substitute, or add various procedures or components as appropriate. For instance, features described with respect to certain configurations may be combined in various other configurations. Different aspects and elements of the configurations may be combined in a similar manner. Also, technology evolves and, thus, many of the elements are examples and do not limit the scope of the disclosure or claims.

A wireless communication system is one in which communications are conveyed wirelessly, i.e., by electromagnetic and/or acoustic waves propagating through atmospheric space rather than through a wire or other physical connection, between wireless communication devices. A wireless communication system (also called a wireless communications system, a wireless communication network, or a wireless communications network) may not have all communications transmitted wirelessly, but is configured to have at least some communications transmitted wirelessly. Further, the term “wireless communication device,” or similar term, does not require that the functionality of the device is exclusively, or even primarily, for communication, or that communication using the wireless communication device is exclusively, or even primarily, wireless, or that the device be a mobile device, but indicates that the device includes wireless communication capability (one-way or two-way), e.g., includes at least one radio (each radio being part of a transmitter, receiver, or transceiver) for wireless communication.

Specific details are given in the description herein to provide a thorough understanding of example configurations (including implementations). However, configurations may be practiced without these specific details. For example, well-known circuits, processes, algorithms, structures, and techniques have been shown without unnecessary detail in order to avoid obscuring the configurations. The description herein provides example configurations, and does not limit the scope, applicability, or configurations of the claims. Rather, the preceding description of the configurations provides a description for implementing described techniques. Various changes may be made in the function and arrangement of elements.

The terms “processor-readable medium,” “machine-readable medium,” and “computer-readable medium,” as used herein, refer to any medium that participates in providing data that causes a machine to operate in a specific fashion. Using a computing platform, various processor-readable media might be involved in providing instructions/code to processor(s) for execution and/or might be used to store and/or carry such instructions/code (e.g., as signals). In many implementations, a processor-readable medium is a physical and/or tangible storage medium. Such a medium may take many forms, including but not limited to, non-volatile media and volatile media. Non-volatile media include, for example, optical and/or magnetic disks. Volatile media include, without limitation, dynamic memory.

Having described several example configurations, various modifications, alternative constructions, and equivalents may be used. For example, the above elements may be components of a larger system, wherein other rules may take precedence over or otherwise modify the application of the disclosure. Also, a number of operations may be undertaken before, during, or after the above elements are considered. Accordingly, the above description does not bound the scope of the claims.

Unless otherwise indicated, “about” and/or “approximately” as used herein when referring to a measurable value such as an amount, a temporal duration, and the like, encompasses variations of ±20% or ±10%, ±5%, or ±0.1% from the specified value, as appropriate in the context of the systems, devices, circuits, methods, and other implementations described herein. Unless otherwise indicated, “substantially” as used herein when referring to a measurable value such as an amount, a temporal duration, a physical attribute (such as frequency), and the like, also encompasses variations of ±20% or ±10%, ±5%, or ±0.1% from the specified value, as appropriate in the context of the systems, devices, circuits, methods, and other implementations described herein.

A statement that a value exceeds (or is more than or above) a first threshold value is equivalent to a statement that the value meets or exceeds a second threshold value that is slightly greater than the first threshold value, e.g., the second threshold value being one value higher than the first threshold value in the resolution of a computing system. A statement that a value is less than (or is within or below) a first threshold value is equivalent to a statement that the value is less than or equal to a second threshold value that is slightly lower than the first threshold value, e.g., the second threshold value being one value lower than the first threshold value in the resolution of a computing system.

1. A multi-hypothesis positioning method comprising:
receiving, at an apparatus from a digital twin function, multi-hypothesis positioning assistance data; and
determining to implement multi-hypothesis positioning based on at least a subset of the multi-hypothesis positioning assistance data.

2. The method of claim 1, wherein the multi-hypothesis positioning assistance data comprise at least one of (1) an indication of feasibility of multi-hypothesis positioning for a positioning scenario of a wireless signaling device, (2) an indication corresponding to at least one multi-hypothesis positioning parameter where the at least one multi-hypothesis positioning parameter comprises at least one of (a) a quantity of hypotheses, and (b) at least one probability distribution function of arrival time of a positioning signal at the wireless signaling device, and (3) an indication of at least one condition corresponding to a multi-hypothesis positioning recommendation.

3. The method of claim 1, further comprising determining what data of the multi-hypothesis positioning assistance data to consider to determine to implement the multi-hypothesis positioning.

4. The method of claim 3, wherein determining what data of the multi-hypothesis positioning assistance data to consider is based on whether the multi-hypothesis positioning assistance data are received from a location management function.

5. The method of claim 1, wherein the multi-hypothesis positioning assistance data comprise a recommendation to implement multi-hypothesis positioning, and wherein determining to implement multi-hypothesis positioning comprises following the recommendation to implement multi-hypothesis positioning.

6. The method of claim 1, wherein the multi-hypothesis positioning assistance data comprise at least one recommended multi-hypothesis positioning parameter, and wherein determining to implement multi-hypothesis positioning comprises determining whether to implement multi-hypothesis positioning using the at least one recommended multi-hypothesis positioning parameter.

7. The method of claim 1, further comprising operating an artificial intelligence model based on at least some of the multi-hypothesis positioning assistance data.

8. The method of claim 7, wherein operating the artificial intelligence model based on at least some of the multi-hypothesis positioning assistance data comprises at least one of selecting the artificial intelligence model based on at least some of the multi-hypothesis positioning assistance data, and using at least some of the multi-hypothesis positioning assistance data as input to the artificial intelligence model.

9. An apparatus, for implementing multi-hypothesis positioning, comprising:
at least one transceiver;
at least one memory;
at least one processor, communicatively coupled to the at least one transceiver and the at least one memory, configured to:
receive, via the at least one transceiver from a digital twin function, multi-hypothesis positioning assistance data; and
determine to implement multi-hypothesis positioning based on at least a subset of the multi-hypothesis positioning assistance data.

10. The apparatus of claim 9, wherein the multi-hypothesis positioning assistance data comprise at least one of (1) an indication of feasibility of multi-hypothesis positioning for a positioning scenario of a wireless signaling device, (2) an indication corresponding to at least one multi-hypothesis positioning parameter where the at least one multi-hypothesis positioning parameter comprises at least one of (a) a quantity of hypotheses, and (b) at least one probability distribution function of arrival time of a positioning signal at the wireless signaling device, and (3) an indication of at least one condition corresponding to a multi-hypothesis positioning recommendation.

11. The apparatus of claim 9, wherein the at least one processor is configured to determine what data of the multi-hypothesis positioning assistance data to consider to determine to implement the multi-hypothesis positioning.

12. The apparatus of claim 11, wherein to determine what data of the multi-hypothesis positioning assistance data to consider the at least one processor is configured to determine whether the multi-hypothesis positioning assistance data are received from a location management function.

13. The apparatus of claim 9, wherein the multi-hypothesis positioning assistance data comprise a recommendation to implement multi-hypothesis positioning, and wherein to determine to implement multi-hypothesis positioning the at least one processor is configured to determine to follow the recommendation to implement multi-hypothesis positioning.

14. The apparatus of claim 9, wherein the multi-hypothesis positioning assistance data comprise at least one recommended multi-hypothesis positioning parameter, and wherein to determine to implement multi-hypothesis positioning the at least one processor is configured to determine to implement multi-hypothesis positioning using the at least one recommended multi-hypothesis positioning parameter.

15. The apparatus of claim 9, wherein the at least one processor is configured to operate an artificial intelligence model based on at least some of the multi-hypothesis positioning assistance data.

16. The apparatus of claim 15, wherein to operate the artificial intelligence model based on at least some of the multi-hypothesis positioning assistance data the at least one processor is configured to at least one of select the artificial intelligence model based on at least some of the multi-hypothesis positioning assistance data, and use at least some of the multi-hypothesis positioning assistance data as input to the artificial intelligence model.

17. An apparatus, for implementing multi-hypothesis positioning, comprising:
means for receiving, from a digital twin function, multi-hypothesis positioning assistance data; and
means for determining to implement multi-hypothesis positioning based on at least a subset of the multi-hypothesis positioning assistance data.

18. The apparatus of claim 17, wherein the multi-hypothesis positioning assistance data comprise at least one of (1) an indication of feasibility of multi-hypothesis positioning for a positioning scenario of a wireless signaling device, (2) an indication corresponding to at least one multi-hypothesis positioning parameter where the at least one multi-hypothesis positioning parameter comprises at least one of (a) a quantity of hypotheses, and (b) at least one probability distribution function of arrival time of a positioning signal at the wireless signaling device, and (3) an indication of at least one condition corresponding to a multi-hypothesis positioning recommendation.

19. The apparatus of claim 17, further comprising means for determining what data of the multi-hypothesis positioning assistance data to consider to determine to implement the multi-hypothesis positioning.

20. The apparatus of claim 19, wherein the means for determining what data of the multi-hypothesis positioning assistance data to consider comprise means for determining whether the multi-hypothesis positioning assistance data are received from a location management function.
